(19) United States
(12) Patent Application Publication
(10) Pub. No.: US 2023/0183097 A1
(43) Pub. Date: Jun. 15, 2023

(54) LIQUID TREATMENT SYSTEM AND METHOD

(71) Applicant: Walter Jacob BAUER, Baden (CA)

(72) Inventor: Walter Jacob BAUER, Baden (CA)

(21) Appl. No.: 17/920,944

(22) PCT Filed: Apr. 30, 2021
(86) PCT No.: PCT/CA2021/050602

§ 371 Date: Oct. 24, 2022

Related U.S. Application Data
(60) Provisional application No. 63/018,880, filed on May 1, 2020.

(51) Int. Cl. C02F 1/34; C02F 1/467; C02F 1/463; C10G 33/02; C02F 1/461

(52) U.S. Cl. CPC C02F 1/34; C02F 1/4672; C02F 1/463; C10G 33/02; C02F 1/46104; C02F 2101/325

(57) ABSTRACT

Provided is a method for treating a liquid, the method including: receive a liquid; passing the liquid through a generator to cut and shear the liquid and releasing the resultant liquid for use. Also provided is a liquid treatment system including: a source of liquid; a generator in fluid communication with the liquid source which cuts and shears the liquid; a pump which produces liquid flow through the system; and an outlet through which the treated liquid flows.

### TECHNICAL FIELD

The present disclosure relates to a system and a method of treating various types of liquids and liquid solutions including water. In particular, the present disclosure relates to a system and method for treating a liquid with an electrocatalytic device.

### BACKGROUND

Improvements within the liquid and water treatment industry are continuously being sought after to provide liquid treatment systems which are capable of more effectively purifying the liquid or water that is being treated and to provide a higher quality product. It has been discovered that certain imperfections within the metal used within liquid treatment systems can have a detrimental effect on the performance of the liquid treatment system and the purification of the treated liquid to the degree that the liquid treatment system might not function as intended.

Liquid treatment systems typically include a series of rotating discs within a liquid treatment that treat the liquid or water as it passes through the treatment portion of the liquid treatment system. The rotating discs are made from a non-corrosive metal such as stainless steel and are cut into a specific shape for a particular liquid treatment system. It has been found that improvements in treatment of the liquid or water can be obtained by increasing the ionic reactive surface of these discs. In the past, the only ionic reactive surface of these discs was the surface area of the disc that was laser cut or water jet cut to form the desired shape of the disc. This amounts to only 1/7^{th} of the surface area of the disc. When investigated under a microscope, it was further discovered that the cutting action of the water jet and laser cutter was not uniform and did not provide an optimal surface cut. It has been found that by improving the surface cut of the disc elements of the liquid treatment system, increasing the ionic reactive surface of the disc elements and increasing the ionic electrochemical reaction within the liquid itself, a more purified and cooler liquid can be obtained.

### BRIEF DESCRIPTION OF THE DRAWINGS

FIG. 1 is a perspective view of a molybdenum-activating liquid cooling generator according to one embodiment of the present disclosure.

FIG. 2 is a full, outer view (a), transparent view (B) and longitudinal cross sectional view (C) of the molybdenum-activating liquid cooling generator of FIG. 1.

FIG. 3 is a graph illustrating a side view of a treatment portion of a molybdenum-activating liquid cooling generator according to one embodiment of the present disclosure.

FIG. 4 is a graph illustrating an isometric view of the treatment portion of the molybdenum-activating liquid cooling generator of FIG. 1.

FIG. 5 is a graph illustrating a front view of a disc-like element of the molybdenum-activating liquid cooling generator according to one embodiment of the present disclosure.

FIG. 6 is an enlarged view of a longitudinal cross section of the molybdenum-activating liquid cooling generator of FIG. 1 showing the flow of a liquid solution through the molybdenum-activating liquid cooling generator.

FIG. 7 is an embodiment of the inventive system for providing a cooled molybdenum-activated liquid.

FIG. 8 is an embodiment of the inventive system for providing a cooled molybdenum-activated liquid.

FIG. 9 is a perspective view of an inside of the treatment portion of a static spiral mixer according to one embodiment of the present disclosure.

FIG. 10 is a perspective view of a disc-like element element and a shaft of a static spiral mixer according to one embodiment of the present disclosure.

FIG. 11 is a front view of a disc-like elements element of a spiral mixer according to one embodiment of the present disclosure.

FIG. 12 is a side view of a static spiral mixer according to one embodiment of the present disclosure.

FIG. 13A Illustrates a set-up of 7 disc-like elements within a reverse flow apparatus according to one embodiment.

FIG. 13B An embodiment of a set-up of 7 disc-like elements within the same reverse flow apparatus illustrated in FIG. 13A.

FIG. 14 illustrates a system containing a spiral mixer in accordance to one embodiment of the present disclosure.

FIG. 15 is a representation of a photograph of centrifuge tubes containing emulsions processed with the reverse flow apparatus of the present disclosure. The emulsions were taken from different levels of a waste tank. The sample in the first tube from the left was taken from a cone at the bottom of a waste tank. The samples become successively more clear from left to right with the fourth tube from the left taken from the top of the waste tank being the most clear.

### DETAILED DESCRIPTION

Definitions

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “containing”, “including”, “having” and “comprising” typically indicate “including without limitation”). Examples of limiting terms include “consisting of” and “consisting essentially of”. Singular forms including in the claims such as “a”, “an” and “the” include the plural reference unless expressly stated otherwise.

The term “fluid” includes liquids and/or gases.

The term “liquid” is used to include liquid solutions and/or emulsions (oil-in-water, or water-in-oil emulsions) and/or liquids containing a single component.

The term “waste oil” used herein includes a fossil fuel waste oil, a waste edible oil, and a mixture thereof and to solution and emulsions containing waste oil.

The terms “treat,” “treating,” and “treatment” when used in relation to treating a disease, refer to a method of alleviating or abating the disease and/or its attendant symptoms.

In order to aid in the understanding and preparation of the within invention, the following illustrative, non-limiting, examples are provided.

### Liquid Cooling Generator

The inventive system and method of the present disclosure effectively produces a cooled turbulent flow in a source of liquid material without changing the elemental composition of the source liquid material and without requiring the use of toxic or harmful additives. The system and process may be implemented in a stationary, installed unit, or in a portable unit. The inventive system may also be retrofit in existing liquid solution distribution systems, such as water distribution systems. Although several specific embodiments are described, it will be apparent that the inventive system and method is not limited to the embodiments illustrated, and that additional embodiments may also be used. The cooled turbulent liquid solution of the present invention is highly effective in a variety of applications described herein below.

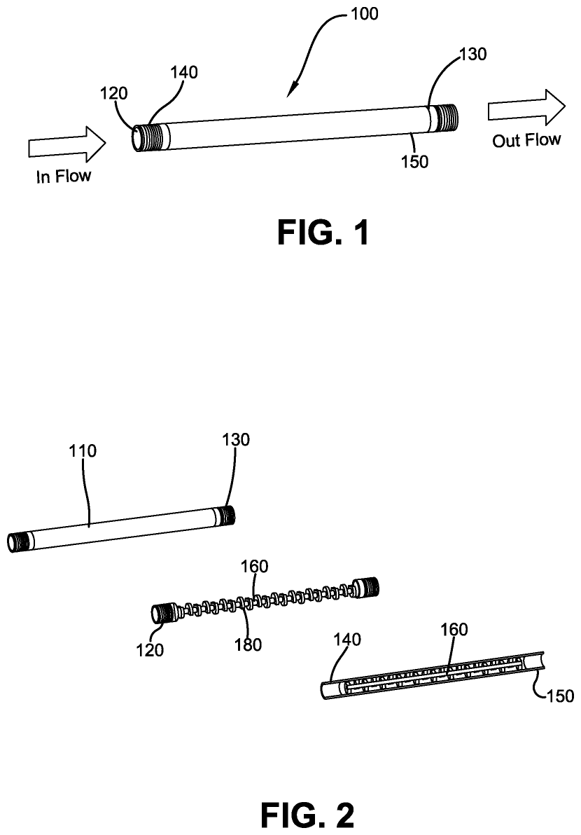

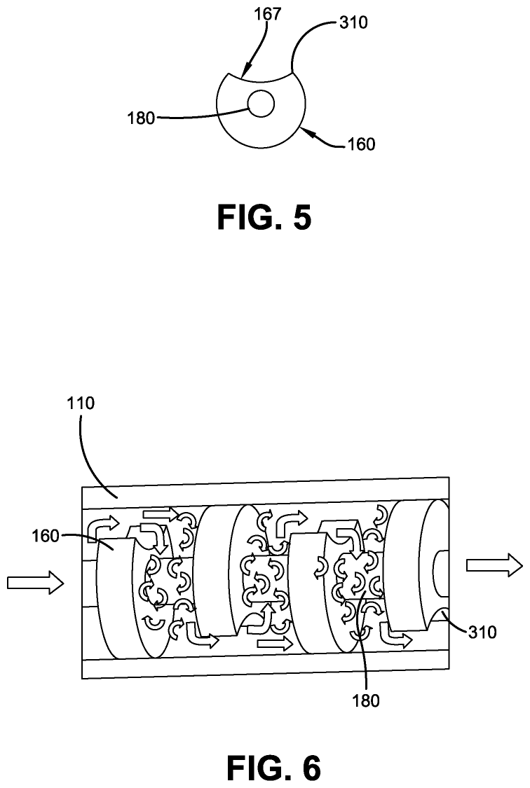

Accordingly, the liquid treatment system disclosed herein includes an improved liquid cooling generator. With reference to FIGS. 1-6, the improved liquid cooling generator 100 may include a housing 110 having an inflow portion 140 for receiving a source liquid solution, a treatment portion 110 having a series of sequential cavitation zones and shear planes, and an out-flow portion 150 for releasing a cooled turbulent liquid which may be more effectively and easily purified.

With reference to FIGS. 1 and 2, the housing 110 may take a substantially tubular form. The inlet 140 and outflow 150 portions may include a threaded boss 120 and 130 at each end. The housing 110 and bosses 120 and 130 are preferably made of a substantially inert material, such as polyvinyl chloride (PVC).

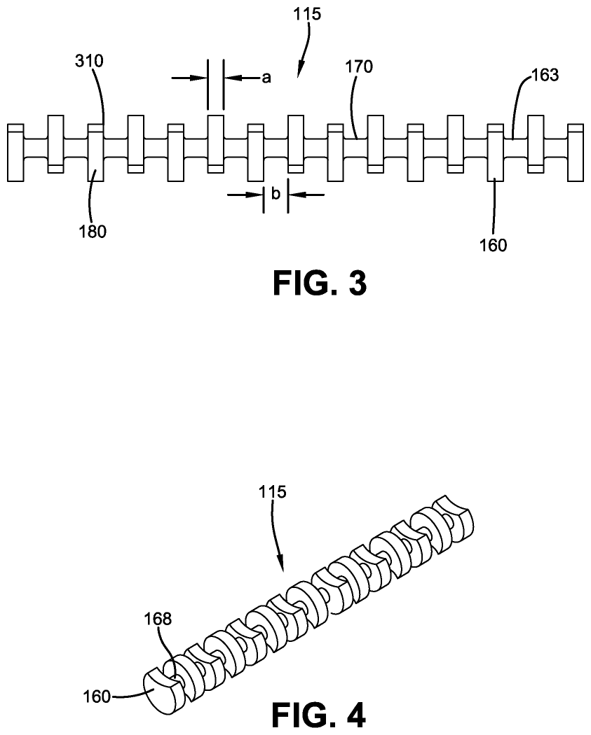

With reference to FIGS. 2 and 3, the series of sequential cavitation zones and shear planes included within the housing 110 may be obtained by having a series of spaced apart elements 160 which extend axially through the housing 110 and may be interposed between the inflow and the outflow portions 140, 150. Each element 160 may take the form of a disk. The elements 160 may be supported upon a central rod 180. The elements 160 may be held in spaced relation to each other.

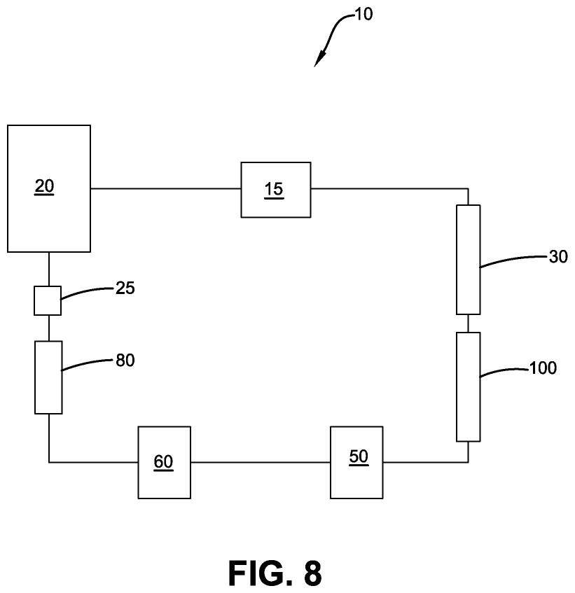

With reference to FIGS. 2B and 2C, 5, 6 and 8, the treatment portion 115 of the liquid cooling generator may include a series of sequential cavitation zones 190 and surface planes 168. The series of sequential cavitation zones 190 and surface planes 168 may be enabled by having a generally elongated member 180 having a series (2 or more) of spaced apart elements 160 which extend axially through the housing 110 and may be interposed between the inflow and the outflow portions of the liquid cooling generator. Between 2 and 30 spaced apart elements 160 may be used. More than 30 spaced apart elements 160 may also be used. Each element 160 may take the form of a disc having a lateral Surface A on one side and a lateral Surface B on an opposing side with a planar Surface C positioned horizontally between Surface A and Surface B and extending around the circumference of the disk. The disc-like elements 160 (also referred to as ring elements) may be supported upon or mounted on a central rod or shaft 180. With reference to FIG. 8, the disc 160 may include opposite walls 161, 162 (also referred to as Surface A and Surface B), and a peripheral or side wall 163. Surface A may face the inflow portion and Surface B may face the outflow portion of the liquid turbulent generator. The peripheral wall 163 may extend between opposite Surface A and Surface B. The disc-like elements 160 may be held in spaced relation to each other. The elements 160 may be separated from one another by a space 170.

### Static Spiral Mixer/Reverse Flow Apparatus

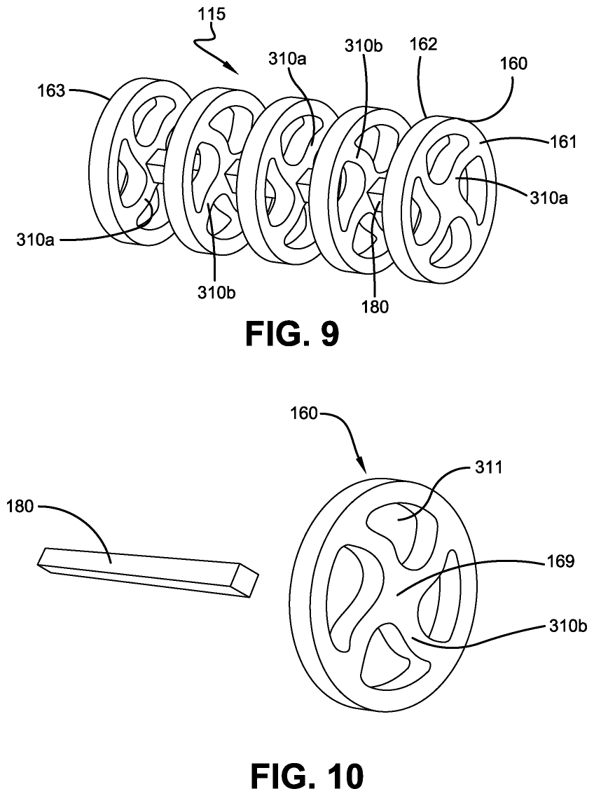

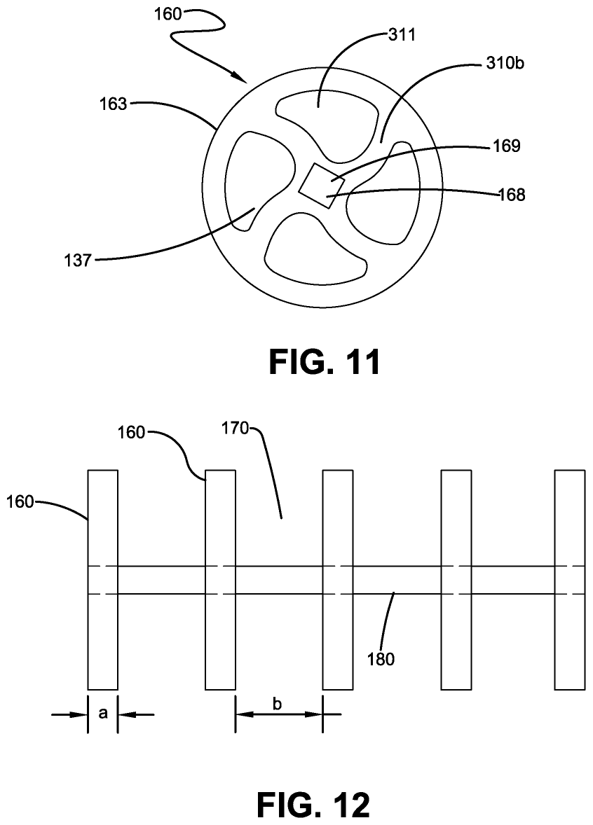

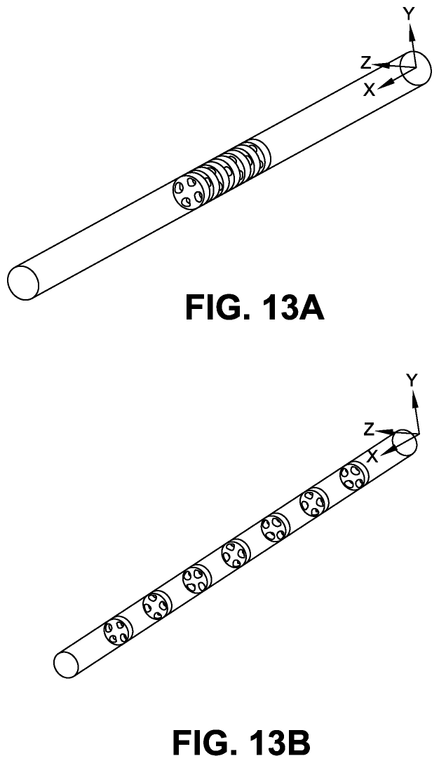

In a second embodiment, the disc-like elements of the liquid cooling generator or liquid cooling generating system may be configured to form a reverse flow apparatus (also referred to as a static spiral mixer because it has no moving parts) 115 as shown in FIGS. 9 to 12 and FIGS. 13A and 13B.

The inventive static, reversing flow apparatus, system and method of the present disclosure effectively converts the flow of a liquid from laminar to a turbulent flow. The inventive apparatus, system and method of the present disclosure effectively produces mixtures of liquids, or liquids with solids or liquids with gases, and without requiring the use of catalysts toxic or harmful additives or chemicals. In some embodiments, the term “mixture” is used to refer to the output of the apparatus of the present disclosure. The system and process may be implemented in a stationary, installed unit, or in a portable unit. The inventive system may also be retrofitted in existing liquid solution distribution systems, such as water distribution systems. Although several specific embodiments are described, it will be apparent that the disclosure is not limited to the embodiments illustrated, and that additional embodiments may also be used. The liquid mixtures produced by the methods of the present disclosure are highly effective in a variety of application as it will be described herein below. The apparatus, systems and methods of the present disclosure do not require external air or gas to produce the mixtures.

In embodiments, the housing of the reverse flow apparatus/static spiral mixer takes a substantially tubular form. The inlet and outflow portions may include a threaded boss and at each end. The housing and bosses are preferably made of a substantially inert material. In embodiments examples of such inert material include polymers such as polyvinyl chloride (PVC).

Each disc-like element 160 within the treatment portion of the reverse flow apparatus/static spiral mixer may take the form of a disc. The disc-like elements 160 of the reverse flow apparatus/static spiral mixer may be supported upon or mounted on a central rod or shaft 180. The disc 160 may include opposite sides 161, 162, and a peripheral or side wall along the circumference 163 of the disc-like element 160. One side 161 may face the inflow portion and the opposite side 162 may face the outflow portion of the generator. The peripheral wall 163 may extend between opposite shear walls 161, 162. The disc-like elements 160 may be held in spaced relation to each other. The elements 160 may be separated from one another by a space 170.

Each element 160 may include at least one S-shaped member 310 extending from one point in the circumference 163 to another point in the circumference, while crossing the center 169 of the disc-like element 160, thereby creating apertures 311 between S-shaped members 310 of one disc-like element 160. Each S-shaped member 310 may include edges 167. The edges 167, which may have a scallop design, may be sharp. Preferably the disc-like elements may be made laser cut. The width “a” of each disc-like element 160, is about one half or less of the distance “b” between two consecutive disc-like elements 160. The center of each element 160 may include an aperture 168 in the center 169 to receive the shaft 180. The disc-like element illustrated in FIG. 10 does not show an aperture to receive the shaft 180, however, this illustration is just an example, and an aperture should be present to receive the shaft.

The axially successive disc-like elements 160 of the static spiral mixer 115 are arranged along the rod 180. The elements 160 may be arranged on rod 180 in a twister or spiral arrangement, such that at least one disc-like elements 160 has its S-shaped member 310 in a forward-facing position (310a) and at least one disc-like element has its S-shaped member in a reverse-facing position (310b) (i.e. at least one disc-like element is inverted or flipped relative to another disc-like element in the mixer). FIG. 9 illustrates an alternating pattern in which a disc-like element having the S-shaped member 310 in a forward-facing position (310a) is followed by a disc-like element with the S-shaped member in a reverse-facing position (310b). However, it should be understood that the present invention also covers a situation in which two or more disc-like elements with the same S-shaped member 310 are next to one another as long as at least one disc-like element has the reverse S-shaped member 310.

Each disc-like element 160 of the static spiral mixer may be disposed substantially perpendicular to the flow of the untreated liquid within the housing 110, such as the elements 160 may substantially block any direct fluid flow through the housing 110 and as a result the fluid flow passes through the apertures 311 in each of the disc-like elements 160. Due to the twist arrangement of the S-shaped members 310, the fluid flow between the disc-like elements 160 is turbulent and by virtue of the differing cross-sectional areas of the apertures 311 in each disc-like element 160, the width of the disc-like element 160, and the space 170 between the disc-like elements 160 the liquid is caused to accelerate and decelerate on its passage through the housing 110 to ensure a turbulent flow over the surfaces of the disc-like elements 160.

### Static Spiral Mixer for Waste Management

In embodiments, the apparatus of the present disclosure is used to facilitate the separation of waste oils from sludge, and to collect waste oil and lubricant materials for recycling. A variety of oil-in-water emulsions can be treated with the apparatus of the present disclosure to recover oil. Hydrocarbons and/or edible oils can be processed with the apparatus of the present disclosure. Oils in the emulsion and oil contaminated materials, include industrial lubricants, contaminated oils and waters, automotive/motor oils, lubricating oils and hydraulic oils. In embodiments, the recovered oils meet government and environmental regulated discharge approval.

A pump may be used to deliver oil-in-water emulsion obtained from a waste tank to an apparatus of the present disclosure in singular or in series of two, three, four, five, six, seven, eight, nine, ten, eleven, twelve, thirteen, fourteen, fifteen, sixteen, seventeen, eighteen to thirty and they can be also in parallel. The processed oil becomes separated from the water and can be recycled or returned back to a waste tank. In aspects the processed oil is a water-in-oil emulsion.

The purpose of this configuration is to allow for processing without re-circulation in a continuous stream to keep the fluid in suspension until it reaches an end destination or be placed in the tank again where it will self-separate according to specific gravity: silt on the bottom, heavy oils, water, light oils on the very top.

No other device may be necessary or can perform the function of the separation which is due to the intense shear of the fluid by the Spiral Static Mixer.

Prior to pumping the oil-in-water emulsion, the emulsion may be heated to aid in the processing.

In embodiments, chemicals may be used to assist in the separation if necessary, depending on the oil water emulsion.

All oil contains some water, so this is for all oil streams including refined oils, fuels, alcohols, ethanol, diesel and Bunker C type fuels.

The process can also be used to desulfurization of oils and fuels.

### Static Spiral Mixer for Viscosity Reduction, Breaking Oil-in-Water Emulsions and Oil Cracking

There are many ways one can reduce the viscosity of oils, including heavy oils such as bitumen in oil sands and oil contaminated solutions. This may be necessary for enabling transportation of bitumen from the well to a refinery or the recycling of the oil in the oil contaminated solutions.

The apparatus of the present disclosure is used, in embodiments, to reduce the viscosity of oil containing liquid materials, such as oil-in-water emulsions, by breaking intermolecular bonding between the oil in the liquid material and the other components in the liquid material. By breaking the bonds between the oil and other substances in the material, the liquid material becomes less viscous. In addition, due to cracking that may be experienced by the oils in the material, smaller hydrocarbon chains have a lower viscosity.

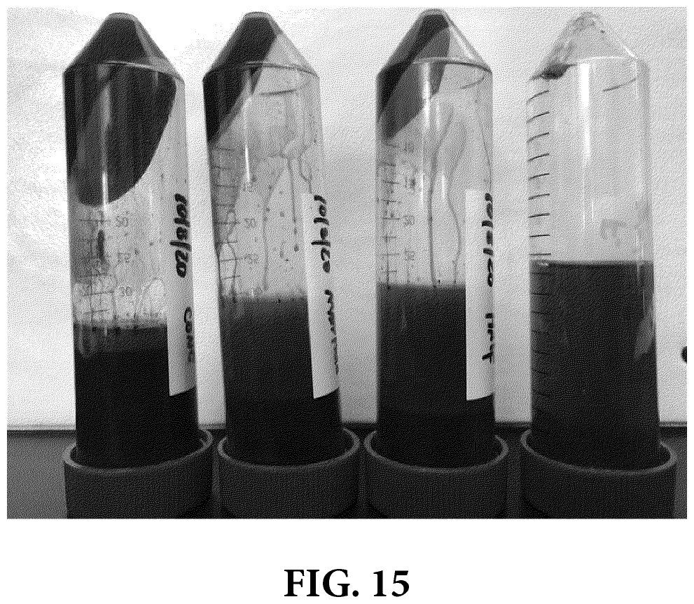

According to certain aspects of the present teaching, the present disclosure relates to methods of cracking or breaking an oil-in-water emulsion. The method may be applied to any oil-in-water emulsions of any general type. An example of oil-in-water emulsions include petrochemicals and oil-containing wastewater. The oil-in-water emulsion may also be part of a secondary oil recovery system. For example, oily wastewater from a plant can be broken using the method of the present disclosure to remove the oil in the oily waste from the water. In order to break the emulsion and remove the oil from the water, the emulsion stored in a tank is delivered to an apparatus of this disclosure, for example with the use of a pump, such as a positive displacement pump. If the emulsion is too dense, then prior to delivery to the apparatus, a less dense emulsion derivative may be obtained. To obtain the oil-in-water emulsion derivative, the original oil-in-water emulsion may first be pyrolyzed (in an oxygen deprived environment). The fumes that emanate are quenched with water resulting in an emulsification fluid. The emulsification fluid, also referred to as the emulsion derivative, is then delivered by a pump, such as a positive displacement pump, to an apparatus of the present disclosure. The emulsion or the emulsion derivative, as the case may be, is then passed through, or treated with, an apparatus of the present disclosure to obtain a processed material, whereby a separate aqueous phase and an oil containing phase is produced (see FIG. 15). All or substantially all of the oil in the processed material separates from the water and the oil can be removed from the water, permitting the clean water to be discarded and the oil to be recycled or discarded in an environmentally friendly manner for oil materials. The processed material includes a separate and distinct oil phase and an aqueous phase. The oil phase in the processed material is comprised of pure oil (i.e. about 100% oil) or is substantially comprised of pure oil in the form of a water-in-oil emulsion.

As such, in one embodiment, the present disclosure is a method of cracking or breaking an oil-in-water emulsion comprising passing the oil-in-water emulsion, or a derivative of the oil-in-water emulsion, through a reverse flow apparatus or static spiral mixer of the present disclosure to obtain a processed material whereby a separate and distinct aqueous phase and oil phase is produced. In embodiments, the method may further include the step of separating the oil phase of the processed material from the water phase.

Cracking, or refining, is the overall reduction of lengths of hydrocarbon chains, a process that breaks or cracks the heavier, higher boiling-point petroleum fractions into more valuable products such as gasoline, fuel oil, and gas oils. In certain embodiments, the apparatus of the present disclosure is used to crack hydrocarbons contained in a source. Processed oil solutions or emulsions contain more hydrocarbons having shorter carbon chain species relative to untreated control oil solutions or emulsions before the process started, as well as losses of hydrocarbons having longer carbon chains relative to the control sample. The boiling point of the original, untreated liquid source is higher than the boiling point of the treated liquid thereby demonstrating the cracking of the untreated liquid source.

Most static mixer designs are meant for mixing two or more fluids either through division or homogenization. The device of this disclosure is designed primarily as a molecular shearing device. Its design gives it enough shearing strength to break both inter (weak molecular bonds) and intra (strong molecular bonds). In certain embodiments, shearing strength sufficient for cracking a water oil emulsion is provided by using a Number 5 Grade water jet cut for cutting the edges of the disc-like elements. The apparatus of the present disclosure has clearly demonstrated the ability to break both inter and intra molecular bonds with a water oil emulsion. Independent of the emulsion constituents there is always both an inter and intra molecular bond separation. This separation results in the fluid consistently separating into its separate components by either specific gravity or into a filterable suspension. Furthermore, fluids can be processed to a desired separation by Specific Gravity Fluid Tank Separation or Gas Chromatography Analysis given enough processing time and pressure. For instance, a C-40 Oil can be reduced to smaller chains by the length of time and fluid pressure force of processing. This results in a change in viscosity and chemical composition of the mixture. This is far beyond what a traditional static mixer was ever imagined to be able to achieve.

The reverse flow apparatus/static spiral mixer replaces the traditional hydrocracking process in that a refinery is not required to crack the oil in water emulsion. The reverse flow apparatus/static spiral mixer of the present disclosure changes the existing paradigm of breaking oil emulsions either using solvents and/or heat distillation extraction. This device requires no heat (e.g., no kiln), ultrasound or solvents to break inter and intra molecular bonds and separate water from an oil emulsion. The apparatus of the present disclosure is an ultra-low energy method of separating oil from water so that the carbon footprint in traditional petroleum industry can be dramatically reduced. It can be referred to as Low Energy Refining. To crack an oil-in-water emulsion, a sufficient amount of pressure must be supplied to achieve a sufficient friction or shearing force for cracking. This cracking pressure is typically in the range of 400 to 600 psi and is supplied by gear pumps. The reverse flow apparatus/static spiral mixer of the present disclosure uses a disc-like element comprising a molybdenum-nickel alloy which allows for cracking an oil-in-water emulsion at pressure ranging from 70 or about 70 psi to 125 or about 125 psi. The cracked oil has a carbon length ranging from about C20 to about C40 which provides a low viscosity product that is easily flowable through down pipes. The cracked oil is slick in that it has low adhesion properties, a relatively low viscosity and low drag as it flows through pipes. Use of butane and other additives for lowering viscosity and improving flowability are rendered unnecessary with the reverse flow apparatus/static spiral mixer as the treated fluid is capable of achieving a sufficiently low viscosity. In separating emulsions temperatures have ranged from 15 Degrees Celsius to 21 Degrees Celsius which were the ambient conditions. Less energy is needed to pump the oil water emulsion as tests demonstrate greater than a 50% reduction in pumping energy due to the decreased viscosity of the fluid. Use of flocculants for filtering are rendered unnecessary as the reverse flow apparatus/static spiral mixer naturally flocculates impurities and eliminates the need for such additives. The reverse flow apparatus/static spiral mixer including disc-like elements comprising a molybdenum-nickel alloy has been shown to achieve over a 90% reduction in the amount of sulfur within treated water oil emulsions. Specifically, treated water oil emulsions have been shown to reduce sulfur content from 1.36 wt. % or about 14,000 ppm to less than 1,400 ppm or less than 0.14% wt. % before sulfur is coagulated and filtered out of the fluid. Subsequent filtration of treated fluids reduces sulfur content and purifies treated fluids even further as sulfur content can be reduced to less than 50 ppm or 0.005 wt. % with subsequent filtration. It is noted that the current Maritime Fuel Regulation requires 0.5 wt. % sulfur content in marine fuels used by ocean vessels (See “The Effects of Changes to Marine Fuel Sulfur Limits in 2020 on Energy Markets” at https://www.eia.gov/outlooks/studies/imo/). Thus, the reverse flow apparatus/static spiral mixer provides a significant improvement in reducing sulfur content that goes well beyond what is mandated by current regulations.

The reverse flow apparatus/static spiral mixer may also be used to improve mercury filtration. Because of its acidic reactive nature, mercury can be difficult to remove from fluids. The reverse flow apparatus/static spiral mixer, however, allows mercury to solidify and crystallize through electrical coagulation. This increases the size of mercury crystals within the fluid and allows mercury to more easily be filtered from the fluid through various processes such as carbon filtration without the use of coagulants or flocculants. In one application, a sample of fluid was passed through a reverse flow apparatus/static spiral mixer having disc-like elements made from 316L stainless steel. The sample contained an initial mercury content of 12 to 14 ppb (parts per billion). After running the sample through the reverse flow apparatus/static spiral mixer and subsequently through a carbon filtration system, the sample had a mercury content of less than 1 ppb (part per billion). In larger scale applications, the reverse flow apparatus/static spiral mixer can reduce the mercury content from 6 to 8 ppm (parts per million) to less than 1 ppb (part per billion). The filtration of mercury to this degree results in an initially cloudy, whitish fluid becoming visibly clear and allows treated fluid or water to be discharged into the ground. This process may be used for other metals including toxic metals such as uranium and precious metals such as platinum and gold.

Further improvements in achieving smaller carbon chained oils, lower viscosity products, better flowability and increased purity can be achieved by increasing pressure within the reverse flow apparatus/static spiral mixer above 125 psi, for example up to about 400 to about 600 as used in traditional hydrocracking processes or beyond. Water treated with the reverse flow apparatus/static spiral mixer may be used to rejuvenate wells. Use of the reverse flow apparatus/static spiral mixer as described above also allows for greater recovery of oil from wells. For example, traditional hydrocracking processes allow for only a 25% yield of oil from oil-in-water emulsions whereas the present process allows for recovering up to an additional 50% or more oil remaining within the well. Thus, the reverse flow apparatus/static spiral mixer provides for a green hydrocracking process.

In experimental testing, Bunker A oil was run through a static spiral mixer comprising 21 disc-like elements made from 316L stainless steel comprising 1.5 wt. % molybdenum. The experimental test run successfully cracked the Bunker A oil in 10 minutes at a pressure of 125 psi. A burn test was subsequently conducted to prove that cracking of the oil had in fact occurred. The results of the burn test revealed that untreated Bunker A oil burned in approximately 18 minutes emitting relatively low heat whereas the treated Bunker A oil burned in 12 minutes emitting a significantly higher degree of heat equivalent to that of burning gasoline or diesel fuel.

In further experimental testing, motor oil and diesel fuel were run through a static spiral mixer comprising 21 disc-like elements made from 316L stainless steel comprising 1.5 wt. % molybdenum. The treated motor oil was subsequently inserted within the motor of a vehicle which was run with the treated diesel fuel. The results of the test indicate an improvement in fuel efficiency of approximately 10 miles per gallon as the vehicle's fuel efficiency increased from approximately 17 miles per gallon to approximately 27 miles per gallon. It is contemplated that this treatment may also be used in other vehicle fluids such as radiator fluid or coolant, transmission fluid, brake fluid, power steering fluid, etc. for improved vehicle performance.

In further testing, water oil emulsions treated through a reverse flow apparatus/static spiral mixer including disc-like elements comprising a molybdenum-nickel alloy were analyzed for their distillation characteristics according to gas-chromatographic high temperature simulation distillation method ASTMD-7169. The results of the analysis are provided in the Tables below.

TABLE 1
Sample: F-1418 OR345404 Emulsion/Oil/Sludge CWMNW
Boiling Point Distribution of Crude Oils and Vacuum
Residues by Gas Chromatography ASTM D7169

| | Results ° C. |
|---|---|
| Initial Boiling Point | 80 |
| 5% recovered | 171 |
| 10% recovered | 206 |
| 15% recovered | 228 |
| 20% recovered | 247 |
| 25% recovered | 267 |
| 30% recovered | 287 |
| 35% recovered | 307 |
| 40% recovered | 325 |
| 45% recovered | 338 |
| 50% recovered | 352 |
| 55% recovered | 364 |
| 60% recovered | 376 |
| 65% recovered | 389 |
| 70% recovered | 405 |
| 75% recovered | 424 |
| 80% recovered | 456 |
| 85% recovered | 553 |
| 86% recovered | 609 |
| % Recovery | 86.46 |
| % Resid | 13.54 |
| Viscosity, Kinematic, at | 14.23 |
| 40° C., ASTMD 445.c, St. | |

TABLE 2
Sample: F-1419 OR345404 Emulsion/Oil/Sludge CWMNW
Boiling Point Distribution of Crude Oils and Vacuum
Residues by Gas Chromatography ASTM D7169

| | Results ° C. |
|---|---|
| Initial Boiling Point | 82 |
| 5% recovered | 166 |
| 10% recovered | 200 |
| 15% recovered | 223 |
| 20% recovered | 243 |
| 25% recovered | 261 |
| 30% recovered | 277 |
| 35% recovered | 296 |
| 40% recovered | 312 |
| 45% recovered | 329 |
| 50% recovered | 341 |
| 55% recovered | 352 |
| 60% recovered | 364 |
| 65% recovered | 374 |
| 70% recovered | 387 |
| 75% recovered | 401 |
| 80% recovered | 416 |
| 85% recovered | 436 |
| 90% recovered | 471 |
| 95% recovered | 577 |
| 96% recovered | 640 |
| % Recovery | 96.27 |
| % Resid | 3.73 |
| Viscosity, Kinematic, at 40° | 13.06 |
| C., ASTMD 445.c, St. | |
| Sulfur by X-Ray Fluorescence | 1.335 |
| Spectroscopy. LOD = 0.01 | |
| wt %, ASTM D 4294, wt. % | |
| PCBs in Liquid and Solid Wastes: Oils | <10 |
| and Sludges, etc. ASTMD 6160.a, ppm | |
| Ash Content of Petroleum | 0.04 |
| Products, ASTM D 482, wt. % | |
| Flash Point, Pensky-Martens Closed | 48 |
| Cup, Flash Point, ASTMD 93, ° C. | |
| Chlorine, Total, by Microcoulometry, | 16.8 |
| Total Chloride, EPA 9076, ppm | |
| Heath of Combustion by Bomb | Results, |
| Calorimeter, ASTM D 240 | BTU/lb |
| Gross Heat of Combustion | 17,249 |
| Net Heat of Combustion | 16,721 |
| (From Gross Heat) | |

TABLE 3
Sample: F-1419 OR345404 Emulsion/Oil/Sludge CWMNW
Metals in Water or Aqueous Matrices by ICP-AES, ASTM D1976

| | Results mg/KG |
|---|---|
| Silver | <1.0 |
| Aluminum | 15 |
| Arsenic | <1.0 |
| Boron | <1.0 |
| Barium | <1.0 |
| Beryllium | <1.0 |
| Calcium | 54 |
| Cadmium | <1.0 |
| Cobalt | <1.0 |
| Chromium | <1.0 |
| Copper | <1.0 |
| Iron | 66 |
| Potassium | <1.0 |
| Lithium | <1.0 |
| Magnesium | 13 |
| Manganese | 3 |
| Molybdenum | <1.0 |
| Sodium | 7 |
| Nickel | <1.0 |
| Phosphorus | 4 |
| Lead | <1.0 |
| Antimony | <1.0 |
| Selenium | <1.0 |
| Silicon | 2 |
| Tin | <1.0 |
| Strontium | <1.0 |
| Titanium | 1 |
| Thallium | <1.0 |
| Vanadium | 2 |
| Zinc | 2 |

TABLE 4
Sample: F-1419 OR345404 Emulsion/Oil/Sludge CWMNW
ICP scan. ASTM D 5185

| | Results mg/KG |
|---|---|
| Silver | <15 |
| Aluminum | <20 |
| Boron | <15 |
| Barium | <15 |
| Calcium | <20 |
| Chromium | <15 |
| Cobalt | <15 |
| Copper | <15 |
| Iron | <15 |
| Potassium | <40 |
| Magnesium | <15 |
| Manganese | <50 |
| Molybdenum | <15 |
| Sodium | 1430 |
| Nickel | <15 |
| Phosphorus | <15 |
| Lead | <15 |
| Sulfur | <20 |
| Silicon | <15 |
| Tin | <15 |
| Titanium | <1.0 |
| Thallium | <1.0 |
| Vanadium | <1.0 |
| Zinc. | 2 |

In addition to the processes described above, the reverse flow apparatus or static spiral mixer may be used in the treatment of water that is contaminated with Hydrocarbons or Fluorocarbons or also more difficult compounds such as Perfluorooctyl Sulfonate (PFOS). Without this distinct water oil emulsion separation, it is extremely difficult to filter out or mechanical separate these complex chemicals.

### The Disc-Like Elements

The disc-like elements may be laser cut or water jet cut. As illustrated in FIG. 3, the width “a” of each disc-like element 160, and therefore the width of Surface C may be any size suitable for creating a cooled turbulent liquid flow as determined by a person of ordinary skill in the art. As illustrated in FIGS. 3, 4 and 6, the axially successive discs 160 are arranged along the rod 180.

The disc-like elements are made of a corrosion resistant metal or alloy containing molybdenum. In certain embodiments, the disc-like elements comprise greater than 0.5 wt. % molybdenum, greater than 1.0 wt. % molybdenum, greater than 3.0 wt. % molybdenum, greater than 4.0 wt. % molybdenum. In other embodiments, the disc-like elements comprise from about 3 wt. % to about 4 wt. % molybdenum or more. In other embodiments, the disc-like elements may contain up to 5 wt. % molybdenum or up to 10 wt. % molybdenum. In other embodiments, the disc-like elements comprise about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

The metal alloy of the disc-like elements may further comprise about 5.0 wt. % or more nickel, about 10.0 wt. % or more nickel, about 15.0 wt. % or more nickel, about 20.0 wt. % or more nickel, about 25.0 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

The disc-like elements may be made from a stainless steel 300 series or 900 series alloy such as 316 or 316L; 317 or 317L; or 904 or 904L. According to certain aspects of the present teaching, the 300 or 900 series alloy includes a minimum amount of molybdenum. In certain embodiments, the minimum amount of molybdenum is about 3 wt. % of the total weight of the alloy. In further embodiments, the minimum amount of molybdenum is greater than 3 wt. %, or about 4 wt. % of the total weight of the alloy. In further embodiments, the minimum amount of molybdenum is greater than 4 wt. % of the total weight of the alloy. In certain embodiments, the disc-like elements are made from stainless steel 317L. In other embodiments, the disc-like elements are made from stainless steel 904L.

At least one of Surface A, Surface B and Surface C of the disc-like elements may be machined or polished to remove forging scale from the casting process. In certain embodiments, Surface A and B may be machined or polished to remove forging scale and in other embodiments, Surface A, B and C are machined and/or polished to remove forging scale from the casting or pickling process. According to certain aspects of the present teaching, 100% of the milling scale comprising dielectric contaminants are removed from the surface of the disc-like elements. The machining and/or polishing the disc-like elements to remove scale from the casting process is completed to a Number 4 Grade or any other grade deemed suitable to a person of ordinary skill in the art. In certain cases, the thickness of the disc-like elements is reduced from ⅝ inch to ¼ inch by machining and/or polishing thereby exposing the bare metal of the disc-like metal. According to further aspects of the present teaching, the disc-like elements are machined or polished with a non-ionic sanding grit which contains no metal contaminants. According to further aspects of the present teaching, a water just may be used to cut one or more edges of the disc-like elements. The water jet cut of the disc-like elements may be completed using a Number 5 Grade water jet cut or any other grade deemed suitable to a person of ordinary skill in the art. According to certain aspects of the present teaching, the disc-like elements are covered in plastic during the water jet cut. According to further aspects of the present teaching, no heat is applied to the surface of the disc-like elements during the machining and/or polishing and the water jet cutting steps of the disc-like elements.

As shown in FIG. 6, each disc-like element 160 may be disposed substantially perpendicular to the flow of liquid within the housing 110, such as the elements 160 may substantially block any direct fluid flow through the housing 110. In passing through the housing 110, the disc-like elements 160 cause the fluid to accelerate and decelerate to ensure a turbulent flow over the surfaces of the discs 160. The liquid cooling generator may be unidirectional and unipositional as shown by the arrows in FIGS. 1 and 6.

### Molybdenum Activated Liquid Producing System

The system of the present inventive disclosure may be constructed in a variety of different embodiments and may be employed in connection with creating an improved cooling effect within the treated liquid solution which can be more effectively filtered and purified.

The molybdenum-activated liquid producing system includes a liquid cooling generator. In another embodiment, the system includes a source liquid and a treatment module including a liquid cooling generator.

Polar and non-polar liquid, hydrophilic and lipophilic liquid solutions may be used as source liquids for the inventive system and treated to create a molybdenum-activated liquid to produce a treated solution having a cooled turbulent flow. As such, the source liquid may include oils, alcohols, water, solvents, fuels, surfactants, gels, carbohydrates, and so forth.

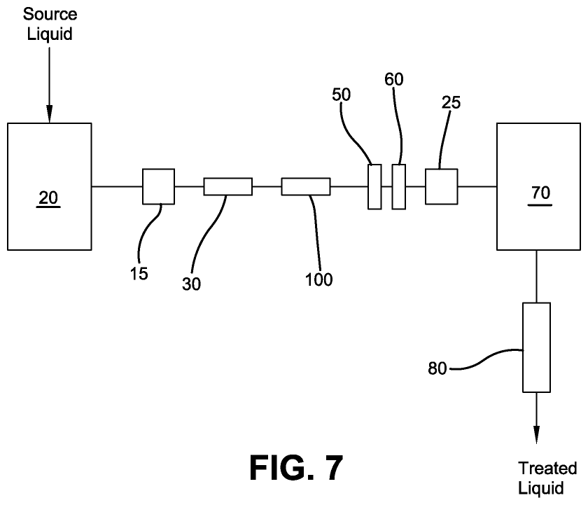

FIG. 7 shows an embodiment of a system 10 for producing a molybdenum-activated liquid. The system may include an optional source liquid pre-treatment system 15, a first liquid cooling generator 30, an optional high zeta potential crystal generator 100, an optional pre-filtration system 50, an optional at least one filtration device 60, and an optional second liquid cooling generator 80. Pre-treatment system 15, liquid cooling generator 30, zeta potential shift crystal generator 100, pre-filtration system 50, filtration device 60, and second liquid cooling generator 80 are in liquid communication with one another and are connected by way of a conduit system. The conduit system may include, for example, pipes, hoses, tubes, channels, and the like.

The source liquid solution, such as water or tap water, oils, alcohols and so forth, is supplied from any suitable source (for example a faucet) and the liquid may be stored in a reservoir 20, or may be supplied continuously or intermittently from any source. The composition of source liquid may be tested and, if necessary, additional minerals and other constituents, compounds and/or solutions may be added to treat the source liquid. In certain embodiments, the source liquid may be treated with any number of compounds including but not limited to alcohols and acids. Examples of compounds which may be used to treat the source liquid include glycerin, lactic acid and hydrochlorous acid. The source liquid may also be treated, prior or subsequent to holding in reservoir 20, in pre-treatment system 15 to substantially remove unwanted contaminants that may interfere with the treatment process, such as debris, oil-containing constituents, and the like. In other cases, the source liquid may be treated prior to passage through the liquid cooling generator, during passage through the liquid cooling generator and/or after passage through the liquid cooling generator.

Source liquid may be added continuously or intermittently to liquid reservoir 20. The liquid solution may flow through the liquid cooling generator with enough force and pressure to initiate an endothermic reaction to create a turbulent flow of liquid with paramagnetic attributes. A pump may be used to generate said force and pressure. As such, the liquid solution may be actively pumped towards the liquid cooling generator of the system. The liquid may also be released using a passive system, such as located in a plume to treat the water before a water turbine or propeller.

In another embodiment, the treated source liquid may next be passed through at least one filtration device 60. In one embodiment, filtration device 60 reduces or substantially eliminates bacteria, viruses, cysts, and the like. Any filtration devices known in the art may be used. Filtration device 60 may include, but not limited to, particle filters, charcoal filters, reverse osmosis filters, active carbon filters, ceramic carbon filters, distiller filters, ionized filters, ion exchange filters, ultraviolet filters, back flush filters, magnetic filters, energetic filters, vortex filters, chemical oxidation filters, chemical addictive filters, Pi water filters, resin filters, membrane disc filters, microfiltration membrane filters, cellulose nitrate membrane filters, screen filters, sieve filters, or microporous filters, and combinations thereof. The treated and filtered liquid may be stored or distributed for use and consumption.

As shown in FIG. 7, before reaching the at least one filtration device 60, the treated liquid may optionally be passed through a zeta potential crystal generator 100. High zeta potential crystal generators are known in the art and generally useful for prevention or reduction of scaling. One known high zeta potential crystal generator 100 is the Zeta Rod™ system. The Zeta Rod™ system increases zeta potential of crystals by electronically dispersing bacteria and mineral colloids in liquid systems, eliminating the threat of bio-fouling and scale and significantly reducing use of chemical additives. Colloids in liquid systems become components of the capacitor and receive a strong boost to their natural surface charge, altering double-layer conditions that govern particle interactions. Mineral scale formation is prevented as the Zeta Rod™ system stabilizes the dispersion of colloidal materials and suspended solids, preventing nucleation and attachment of scale to wetted surfaces. Bacteria remain dispersed in the bulk fluid rather than attaching to surfaces, and cannot absorb nutrition or replicate to form slime and create foul odors. Existing biofilm hydrates excessively, loses bonding strength and disperses. Also, biological fouling, biocorrosion, and scale formation are arrested by the Zeta Rod™ system.

Another known high zeta potential crystal generator 100 is the Sterling Water Anti-Scale Appliance manufactured by Sterling Water Systems, LLC, a subsidiary of Porta Via Water Company. As water passes through the Sterling Water Anti-Scale Appliance, an electrical current is discharged into the water, which decreases the water's surface tension and inhibits the formation of scale and hard water spots from appearing. The inhibition of scale formation is due to the increase of zeta potential of the treated water, which keeps mineral particles from coming in contact with one another.

As shown in FIG. 7, after passage through the liquid cooling generator 30 and the optional high zeta potential crystal generator 100, and before reaching the optional at least one filtration device 60, the treated liquid may optionally be passed through pre-filtration system 50, wherein minerals, such as iron, sulfur, manganese, and the like are substantially removed from the treated source liquid. Pre-filtration system 50 can be, for example, a stainless steel mesh filter. The treated and pre-filtered source liquid, is next passed through the optional at least one filtration device 60, wherein bacteria, viruses, cysts, and the like are substantially removed from the treated liquid.

In the embodiment shown in FIG. 7, pump 25 is provided downstream from liquid cooling generator 30 and treated liquid is released and distributed intermittently or continuously for various liquid system applications. The pump may alternatively be provided upstream from liquid cooling generator 30.

The treated liquid, now purified, cooled and having a high turbulent flow, may be distributed to and stored in a storage container 70, such as a reservoir. In this embodiment, before distribution of the stored treated liquid, the stored liquid may be passed through a second liquid cooling generator 80, for further purification, cooling and generation of turbulence in the treated source liquid. The twice treated liquid may then be distributed for use and consumption. It should be understood that the system may include more than two liquid cooling generators, as such the trice or more times treated liquid may then be distributed for consumption.

FIG. 8 illustrates another embodiment of the molybdenum-activated liquid producing system 10. The system 10 includes a source reservoir 20 that houses the source liquid, an optional source liquid pre-treatment system 15, a first liquid cooling generator 30, an optional high zeta potential crystal generator 100, an optional pre-filtration system 50, an optional at least one filtration device 60, and an optional second liquid cooling generator 80. Pre-treatment system 15, liquid cooling generator 30, high zeta potential crystal generator 100, prefiltration system 50, filtration device 60, and second liquid cooling generator 80 are in liquid communication with one another and are connected by way of a circulating conduit system. Examples of source reservoir 20 may include, but are not limited to, steam boilers, water heaters, cooling towers, drinking water tanks, pools, contained aquaculture ponds, aquariums, industrial water supply reservoirs, garden ponds, and the like. Source liquid may be stored or added continuously or intermittently to source reservoir 20, and the source liquid may be released using a passive system as previously described, or pumped, towards liquid cooling generator 30, where molybdenum activation, cooling and liquid turbulence is generated. Alternatively, the source liquid may be treated, prior or subsequent to holding in source reservoir 20, in pre-treatment system 15 to remove unwanted contaminants that may interfere with the treatment process, such as debris and oil containing constituents.

In the embodiment shown in FIG. 8, source liquid stored in source reservoir 20, pre-treatment system 15, liquid cooling generator 30, high zeta potential crystal generator 100, pre-filtration system 50, filtration device 60, second liquid cooling generator 80, and pump 25 are connected in a loop-like manner by conduit system. Exemplary conduit systems may include, but are not limited to, pipes, hoses, tubes, channels, and the like, and may be exposed to the atmosphere or enclosed. This circulatory or loop-type connection provides continuous or intermittent circulation of the source liquid through source reservoir 20, pre-treatment system 15, liquid cooling generator 30, high zeta potential crystal generator 100, pre-filtration system 50, filtration device 60, and second liquid cooling generator 80.

Continuous or intermittent treatment of the source liquid by the liquid cooling generator system eventually arrives at a point in time where the entire volume of the source liquid within the system 10 is treated by liquid cooling generators 30 and 80. In other words, the entire inventive system 10 may eventually come to an equilibrium-like state where the entire volume of the liquid within the system 10 is treated to generate a cooled molybdenum-activated turbulent liquid.

Before passing through the optional filtration device 60, the treated liquid, may optionally be passed through high zeta potential crystal generator 100 for generating high zeta potential crystals to substantially remove minerals that can cause the formation of scale.

Treated liquid, after passage through liquid cooling generator 30 and the optional high zeta potential crystal generator 100, may optionally be passed through pre-filtration system 50, wherein minerals, such as iron, sulfur, manganese, and the like are substantially removed from the treated source liquid.

In an alternative embodiment, as shown in FIG. 8, after passage through the optional filtration device 60, treated liquid may be passed through an optional liquid cooling generator 80 for incorporating additional molybdenum within the treated liquid, further cooling the treated liquid and for generating additional turbulence within the treated liquid. In this embodiment, the continuous and intermittent treatment of the source liquid by the first liquid cooling generator 30 and second liquid cooling generator 80 eventually arrives at a point in time where the entire volume of the source liquid within the system 10 is treated by first liquid cooling generator 30 and second liquid cooling generator 80.

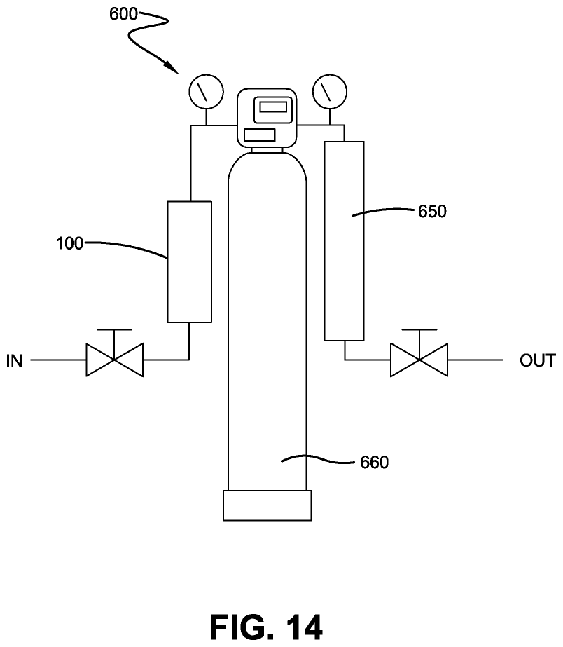

FIG. 14 illustrates an exemplary system which incorporates a static spiral mixer as discussed above. With reference to FIG. 14, the system 600 may include an optional source liquid pre-treatment system (not shown), a spiral mixer 100, optionally at least one filtration device 660, and an optional UV sterilizer 650. The mixer 100, the filter 660 and the UV sterilizer 650 are in liquid communication with one another and are connected by way of a conduit system. The conduit system may include, for example, pipes, hoses, tubes, channels, and the like.

More than two liquid cooling generators may be included in a system. For example, systems having a third liquid cooling generator may be installed. However, systems with 4, 5 or more liquid cooling generators may also be made without difficulty.

### Method of Producing a Cooled Molybdenum-Containing Solution

In one embodiment, the present disclosure relates to a cooled molybdenum-activated solution producing method. The method, in one embodiment, may include passing a source liquid solution through a generator thereby producing the molybdenum-activated solution. The molybdenum-activated solution produced with the methods and systems of the present disclosure may include a relatively high concentration of molybdenum, or an enhanced concentration of molybdenum within the liquid and the molybdenum may be stable within the liquid.

In one step of the method, a source liquid solution may be passed through the generator which may initiate an endothermic reaction. The source liquid may be passed at a suitable pressure. The suitable pressure for the systems shown in FIGS. 9-10 may be about 3.2 bar. The pressure may be about 4 bar and the maximum pressure may be approximately 8 bar.

The endothermic reaction, in which the water cools down from between 2 to 4 degrees Fahrenheit upon first treatment, is indicative of an energy conversion within the water body itself.

The critical material for the elements may be manufactured from a single metal, preferably corrosion resistant metal—for example stainless steel 300 series such as 316L or 317L. The critical ions it produces through the shearing action on water as it passes over the elements/discs 160, then act as catalysts in creating the endothermic reaction.

The reaction may be initiated by the energy of the water flow at a critical pressure over the series of elements within the generator. There may be at least two elements in the generator. In one embodiment, there may be a total of 21 elements in a small generator and 25 elements in a larger generator. More than 25 elements may also be possible.

Each element within the generator may act as a shear plane and may be positioned substantially perpendicular to the liquid solution flow in order that the entire surface of the shear plane is utilized.

The spacing between the elements in the generator may also be adjusted to ensure that there is a suitable degree of cavitation. In one embodiment, the space between two adjacent discs is about 2 times the width of the discs.

With reference to FIG. 8, as liquid (represented by the broad arrows in FIG. 8) enters into the cavitation zone or chamber 190, a number of reactions may be taking place substantially simultaneously, including: cavitation, electrolysis, nanobubble formation, and re-organization of the water liquid structure.

As liquid solution flows through the generator, the simultaneous reactions referred to before, may be replicated sequentially according to the formula n−1 times, wherein “n” is the number of disc-like elements 160 within the housing 110, to increase the kinetic energy frequency of the solution.

The resultant molybdenum-activated liquid solution of the present disclosure has increased paramagnetic qualities that may influence everything the liquid or water is subsequently used for, or used in. It may alter cleaning properties, steam and ice production, thermal transfer and even the energy needed to pump water. It may reduce scaling, biofilm and biofouling and may alter the way in which water interacts with oils and fats.

The method of the present disclosure changes important properties such as oxidation-reduction potential (ORP). By increasing the ORP beyond the capability of existing chemical concentrations, the method of the present disclosure substantially enhances the efficacy of sanitizers. The systems and method of the present disclosure may increase ORP in excess of about 650 mV, enough for killing planktonic organisms instantaneously.

Research has shown that at an ORP value of 650-700 mV, free-floating decay and spoilage bacterial as well as pathogenic bacteria such as E. coli 0157:H7 or Salmonella species are killed within 30 seconds. Spoilage yeast and the more-sensitive types of spore-forming fungi are also killed at this level after a contact time of a few minutes or less.

The WHO (World Health Organization) adopted an ORP standard for drinking water disinfection of 650 mV. When the ORP in a body of water measures 650/1000 mV, the sanitizer in the water is active enough to destroy harmful organisms almost instantaneously.

The molybdenum-activated treated liquid of the present disclosure may condition surfaces by removing oils, enzymes, phenols and other impurities within the liquid. The molybdenum-activated liquid improves the solvency of the liquid and produces a new type of lubricant which serves to deter biofilm attachment to surfaces. The combination of the effects above creates a sanitized surface/system.

The method of the present disclosure may also positively impact pH and increase the solubility effects of water or the liquid. Only water or liquid pressure may be needed for operation.

### The Cooled Molybdenum-Containing Liquid Solution

The treatment portion of the generator has a cooling effect on the liquid that passes through it. Consequently, treated liquid, after passage through the generator, undergoes a temperature reduction as the liquid exits the generator. This temperature reduction may range from between 1° F. to 4° F. and is typically between about 2° F. and about 4° F. or more. The treated liquid exiting the treatment portion of the generator contains a relatively high concentration of molybdenum. Without being bound by any particular theory, it is believed that the molybdenum within the liquid originates from the composition of the disc-like elements, which as mentioned above, contain from about 3 wt. % to about 4 wt. % or more molybdenum. As further mentioned above, scale or impurities from the casting process are machined or polished off of the surface of the disc-like elements. This allows a certain amount of molybdenum nuclei to erode from the disc-like elements and enter the treated liquid as the liquid passes through the generator and contacts the surface plane of the disc-like elements. In short, the machined or polished surfaces of the disc-like elements exposes the metal of the disc-like elements allowing the metal to be available for reaction with the treated liquid. This erosion of molybdenum nuclei occurs at the angstrom level. Thus, the disc-like element may be described as a molybdenum-containing structure. It is further contemplated that the liquid cooling generator may include other structural components that may be described as molybdenum-containing structures having machined or polished surfaces allowing for the transfer of molybdenum to the treated liquid. As molybdenum is introduced into the treated liquid, the treated liquid becomes molybdenum-activated. By molybdenum-activated, it is meant that molybdenum is now present within the treated liquid and is capable of reacting with certain impurities within the liquid in an electro-chemical oxidative reaction. Impurities present within the treated liquid include but are not limited to oil, enzymes and phenols. At a chemical level, it is believed that the molybdenum within the liquid (e.g., water) reacts with certain enzymes within the water to form nitrogenases. The nitrogenases cause a series of protonation and reduction steps of impurities (e.g., oil, phenols and enzymes) which are present in trace amounts within the liquid (e.g., water) resulting nitrogen fixation of impurities within the liquid. The nitrogen fixation in the liquid by molybdenum is believed to create an endothermic reaction resulting in lowering of the overall temperature of the treated liquid. Molybdenum is also believed to act as a catalyst for the oxidation of organic compounds (e.g., enzymes), in particular the oxidation of nitrogen-containing organic compounds, thereby, creating a very powerful electrochemical endothermic reaction on the surface of the metal. Thus, a cooling effect is achieved. The treated liquid may then be passed through a filter (e.g., a reverse-osmosis membrane) to remove these impurities within the liquid. The liquid may then be passed through the a second molybdenum-activating liquid cooling generator within the system allowing for further purification and cooling of the treated liquid.

The molybdenum introduced within the treated liquid by the generators, systems and methods of the present disclosure through the metallurgical reaction described above is stable, does not settle readily and generally stays in suspension for a long period without agitation of the solution. The molybdenum reacts electrochemically within enzymes, phenols, oils and other impurities within the treated liquid which allows for these impurities to be removed from the treated liquid through subsequent filtration steps. The treated liquid has a life span of approximately one year more or less and the machined or polished disc-like elements are sufficiently durable to last many years in use (e.g., 10 years or more).

An example of the improved cooling effect the present liquid treatment system disclosed herein has compared to Applicant's previous nanobubble processor and a standard city water purification system is provided in the tables below. All temperatures are measured in degrees Fahrenheit.

TABLE 5

| Molybdenum-Activating | Standard Water Purification |
|---|---|
| Liquid Cooling Generator | System (City Water) |
| 15.9 | 16.7 |
| 17.7 (with coolant top-up 1.5%) | 18.1 (with coolant top-up 1.5%) |
| 16.3 (with coolant 10%) | 17.7 (with coolant 10%) |

TABLE 6

| | Nanobubble | Standard Water Purification |
|---|---|---|
| | Generator | System (City Water) |
| After Spindle Warm Up | 23.5 | 23.5 |
| During Operation at | 22.7 | 24.6 (middle of spindle)/24.5 |
| Middle of Day | | (outside of spindle) |
| During Operation at | 22.8 | 25.4 (middle of spindle)/25.3 |
| End of the day | | (outside of spindle) |

An example of the improved purification properties of the liquid treatment system including a molybdenum-activated liquid cooling generator is provided in the table below which presents test results obtained from a 10,000 gallon system of water and oil.

TABLE 7

| | |
|---|---|
| Standard Water | Molybdenum-Activating |
| Purification System | Liquid Cooling Generator |

| | | | | |
|---|---|---|---|---|
| Toluene | 17 | ppm | 0.3 | ppm |
| Benzene | 250 | ppm | <20 | ppm |
| Acetone | 4,000 | ppm | <400 | ppm |

With a single pass carbon filtration all chemicals were subsequently reduced to below 10 ppm which indicates an increase in polarity allowing them to be carbon filtered with greater efficiency.

This was achieved with no chemistry being added, just the contaminated water flowing in a bypass mode through the 4% Molybdenum Processor.

Currently the theory behind the oxidation of the chemicals is that the Molybdenum is acting as a catalyst with the small quantity of oxygen in the closed system to form a very powerful oxidative chemical species. It appears to be more powerful and persistent than ozone and is able to achieve great results.

The 4% Molybdenum Processor has also been shown to be capable of completely dissolving a polystyrene based softener resin within water.

In summary, the surface reaction on the disc-like elements forms a molybdenum-activating solution in the water having the following characteristics:
Improved cooling of the fluid
Improved lubricity
Reductive reactions with toluene, acetone, benzene, phenols and an overall cooling of fluids
Production of a chemical species coating on surfaces that is clear and has both hydrophobic and oleophobic properties at the same time preventing impurities such as oil from adhering to or staining surfaces
In machining, the lubricant does not adhere to the surface. This clear chemical species in the coolant keeps the oil and water away from the surface being machined.
The liquid (e.g., water) when measured for lubricity has a significant friction reduction to it. It is able to improve the performance of a reverse-osmosis unit.

### Applications

The liquid endothermic cooling generator and molybdenum-activated liquid producing systems disclosed herein may be used to eliminate bacteria and microorganisms and enhance the over quality of a liquid in a number of liquid systems. These liquid systems, described in greater detail below, may include, but are not limited to, water heaters, water coolers, potable water systems, food processing settings, molecule purification, household water filtration systems, sanitation settings, water softeners, ion exchangers, and medical, dental, and industrial water supply lines, Steam Assisted Gravity Drainage (SAGO) and the like.

Water Heating Systems

The liquid endothermic cooling generator may be integrated with various water heating systems. Water treated by a water heating system provided with the liquid endothermic cooling generator can eliminate bacteria and microorganisms in water, thereby improving the heat transfer efficiency of water heating systems. The liquid heating systems benefiting from the inventive system may include, but are not limited to, continuous water heaters, gas-fueled hot water tank type heaters, electric hot water tank type heaters, re-circulating hot water systems for hot water tanks, continuous water heaters, district heating systems, in-floor heating systems, heat exchangers that utilities hot water and/or steam, or in combination with heat transfer liquids, such as hot oils natural or synthetic.

Water Cooling Systems

The liquid endothermic cooling generator system may be integrated with various water cooling systems. It has been unexpectedly discovered that water treated by a water cooling system provided with a liquid cooling generator system, may eliminate bacteria and microorganisms in liquids, thereby improving the cooling transfer efficiency. The water cooling systems may include, but are not limited to, continuous water coolers, refrigerators, gas and electrically fired evaporators, cooling pads, wet film evaporators, evaporative cooling systems, ground source cooling systems, lake or river water cooling systems, heat exchange cooling systems for lakes, grounds, rivers, or ocean waters, district cooling systems, re-circulating cooling systems, in-floor cooling systems, cooling towers all types makes and models, vacuum applications for industrial cooling on boilers, sugar plant cooking pans, paper mills, petroleum refining plants, mining plants, power plants including: coal, gas, oil, biomass, and nuclear.

Potable Water Systems

The liquid endothermic cooling generator system may be integrated with various potable water systems. It has been discovered that water treated in a system incorporating a liquid endothermic cooling generator, can eliminate bacteria and microorganisms in, and enhance quality of, water, thereby preventing the formation of biofilm in various piping systems, as well as improving the taste of water. The potable water systems may include, but are not limited to, wells, springs, ponds, lakes, rivers, and the like.

Food Processing Industry

Water treated by a system incorporating the liquid endothermic cooling generator, can act as a disinfectant with the addition a minimal amount of chlorine (under 5 ppm) for storage of fresh produce. The treated water may be used to prohibit biofilm formation, for food sanitation and for lowering production costs and increasing shelf life. Further, since lower water surface tension increases solvency of the treated water, water treated in a system incorporating a liquid cooling generator, greatly increases the yield of oils from teas and coffees.

Sanitation Applications

The liquid endothermic cooling generator and molybdenum-activated liquid producing systems, can be integrated with sanitation systems such as swimming pools, power washers, car washes, household washing machines, commercial laundry facilities, household and commercial dishwashing facilities, and the like.

Water Treatment Applications

Liquid endothermic cooling generator and molybdenum-activated liquid producing systems, can be integrated with water treatment applications such as water softeners, ion exchangers, all membrane and filter systems that utilize chlorine, chlorine dioxide, hydrogen peroxide, ozone, and the like.

Medical Industry

Liquid endothermic cooling generator and molybdenum-activated liquid producing systems can be integrated with medical systems and the systems are useful in applications related generally to skin treatments through bathing, spas, and daily usage, improved calcium uptake, improved teeth and conditions, as well as medical, dental, and industrial water lines.

Household Water Filtration Systems

Liquid endothermic cooling generator and molybdenum-activated liquid producing systems may be used in the common household and may be integrated with any filtration device known in the art as described above.

Devices Incorporating Systems and Methods of the Present Disclosure

It is obvious that methods, generators and systems of the present disclosure can be used in conjunction with or retrofit in existing devices and liquid distribution systems, such as water heating systems including, but are not limited to, continuous water heaters, gas-fueled hot water tank type heaters, electric hot water tank type heaters, re-circulating hot water systems for hot water tanks, continuous water heaters, district heating systems, in-floor heating systems, heat exchangers that utilizes hot water and/or steam, or in combination with heat transfer liquids, such as hot oils natural or synthetic; water cooling systems including, but are not limited to, continuous water coolers, refrigerators, gas and electrically fired evaporators, cooling pads, wet film evaporators, evaporative cooling systems, ground source cooling systems, lake or river water cooling systems, heat exchange cooling systems for lakes, grounds, rivers, or ocean waters, district cooling systems, re-circulating cooling systems, in-floor cooling systems, cooling towers all types makes and models, vacuum applications for industrial cooling on boilers, sugar plant cooking pans, paper mills, petroleum refining plants, mining plants, power plants including: coal, gas, oil, biomass, and nuclear; potable water systems including, but are not limited to, wells, springs, ponds, lakes, rivers, and the like; food processing applications such as coffee and tea; sanitation systems including, but are not limited to, swimming pools, power washers, car washes, household washing machines, commercial laundry facilities, household dishwashers and commercial dishwashing facilities, and the like; water softeners; ion exchangers; all membrane and filter systems that utilize chlorine, chlorine dioxide, hydrogen peroxide, ozone, and the like; skin treatment systems through bathing, spas, and daily usage, improved calcium uptake, improved teeth and conditions; medical, dental, and industrial water lines; and any household water filtration systems.

Farms:

Animals provided with water treated with the liquid endothermic cooling generator/molybdenum-activated liquid producing system produce feces with less ammonia (ammonia was converted to organic nitrogen). Manure can be changed and stabilized without producing methane or hydrogen sulfide. Application of treated manure on crops can improve yield, mold resistance, strong root development, insect resistance, and extremely low levels of microtoxins. Field crops may be more drought resistant and the water air interface may allow plants to more easily absorb moisture from the air, dairy products may be aerobic and may have a much longer shelf life and water may be able to destroy listeria cocktails.

Water Based Paint:

Paint manufactured with molybdenum-activated liquid solutions may display faster drying times and have less volatile organic compounds. Paint consumption due to better adhesion may reduced. Paint may demonstrate mold resistance, a brighter appearance and dry smoother.

Beverage Plants:

Molybdenum-activated water may replace the need for CIP (clean in place) for over 1 year in beverage facility bottle cooling tunnels, spraying treated water on conveyors also removed biofilm in a matter of days.

Poultry Processing Plants:

Using processed water with the liquid endothermic molybdenum-activated cooling system in scalders allows for a reduction of temperature and allows birds to come out noticeably cleaner.

Using processed water in a poultry chiller allows birds to obtain a colder temperature with the same amount of refrigeration. Also, chemicals are more effective and a dramatic reduction in pathogen counts can be demonstrated.

Removal of Heavy Metals from Protein Powders

Molybdenum-activated water produced in the systems and methods disclosed herein separate on contact heavy metals from proteins such as iron, lead, manganese, arsenic and others. The reaction is substantially instantaneous and can be used in either a clarifier or a centrifugal separator. The protein when added into a drink, is naturally encapsulated by the molybdenum-activated water thus making it more shelf stable as a colloidal dispersion.

The resulting dried protein material when added to treated water methodology can be used for all dried beverage materials including, teas, coffees, fruit concentrates, medicines, pharmaceuticals, starches, sugars, chocolate mixes, all flavor mixes and all food products including ground meats.

As such, in another embodiment, a method of removing/separating heavy metals from a protein powder is disclosed, the method comprising contacting the protein powder with a suitable molybdenum-activated water, thereby removing/separating the heavy metals from the protein powder.

The method of removing/separating heavy metals from powder protein may also include presoaking ungrounded protein-containing material in a suitable molybdenum-activated liquid, like water, drying the presoaked material, grinding the protein-containing material, for example grinding the material to between a 70 and 100 mesh size, and re-washing the grounded protein-containing material in the molybdenum-activated liquid thereby separating the heavy metals from the grounded, protein-containing material. The method may also include spray drying the wet protein containing material, regrinding the dried protein-containing material and re-washing the dried protein-containing material to separate finer heavy metals, spray drying the protein-containing material or using an alternative drying method. The protein obtained through the method hereby described will be substantially free of heavy metals. The heavy metals thereby separated may then be sold or used in other applications.

Ultra-Disinfection:

Microorganisms (bacteria, fungi, and/or protozoa, with associated bacteriophages and other viruses) can grow collectively in adhesive polymers (mainly EPS) on biologic or non-biologic surfaces to form a biofilm. Biofilms are ubiquitous in natural and industrial environments, and it is now thought that biofilms are the primary habitat for many microorganisms as biofilm can protect microbes including human pathogens from harsh environments such as the presence of antibiotics and biocides (3, 4, 6). It is well known in the industrial world that biofilms routinely foul many surfaces including ship hulls, food processing systems, submerged oil platforms, and the interiors of pipeworks and cooling towers, causing corrosion and metal component failure. Biofilms in water purification systems can be responsible for a wide range of water quality and operational problems. Biofilms can be responsible for loss of disinfectant residuals, biofouling of membranes, microbial regrowth in treated water, and especially, biofilms can be a reservoir for pathogenic bacteria in the system (1, 5, 8). Therefore, biofilms have been associated with a wide range of problems both in industry and in medicine as it is very difficult to eradicate them with common practice.

Tremendous research has been focused on development of novel approaches to control biofilm development (i.e., prevent biofilm formation and eradicate establish biofilms. Surface modifications, chemical disinfectants and other physical and chemical methods have been developed and applied to control biofilm development in different environments but results are not satisfactory and some of these methods are not environmental friendly and has adverse impacts both on human health (2, 9). Novel effective and environmental friendly approaches for biofilm control are still in urgent need.

The molybdenum-activated liquid solution may prevent the formation and/or dissolve biofilm with or without the addition of chemicals.

Air Disinfection and Filtration:

The paramagnetic properties of the molybdenum-activated liquid solution may be used to eliminate mold present within the air in buildings.

Ammonia in restrooms may be converted on contact in men's urinals to organic nitrogen therefore eliminating the ammonia vapors.

Dust may be reduced including biofilm on all surfaces such as glass, wood, tile and metals.

Alcohol Manufacture:

Fermentation time of wines may be reduced by more than 50% with the use of water treated with the liquid endothermic cooling generator.

Less energy may be needed for production of ethanol and/or methanol. Production of ethanol may need up to about 17 percent less energy.

When molybdenum-activated water is used in the dilution of alcohol, it changes the chemical characteristics of the alcohol producing a finer smoother taste.

The molybdenum-activated liquid solution producing system may be used to manufacture alcoholic beverages, including sake, vodka, scotch, rum, rye, gin, brandy, cognac, tequila, mezcal, wine, beers and so forth.

Ice Making:

A Vogt™ commercial ice maker is capable of making harder and more ice in a shorter time period.

Water Heating:

Water heats and dries with less energy and evaporates from surfaces, in some instances, up to about 30 percent faster.

Power Plant Applications:

In steam or thermal power plants, improved efficiencies may be expected due to improved heat transfer, biofouling prevention of membranes and greater lubricity of the water.

Condensing of steam turbines using cooling water can be closed looped using cooling towers and also will be greatly increased for efficiency.

Marine Transportation:

Molybdenum-activated liquid solutions may reduce friction on a ship's hull with the treated water.

Cleaning Devices:

The liquid endothermic cooling generator/molybdenum-activated liquid producing system may be used in power washers, car washes, laundry, carpet cleaning, steam cleaning, hot water cleaning.

Other applications include: injection of hydrogen gas into vegetable oils to reduce catalysis and to improve oil quality, use in bioreactors for methane production, elimination of ferric chloride in waste water due to aerobic condition of the waste water and a neutral ph of the waste water (currently this has been demonstrated in manure pits and is being validated in a food manufacturing facility. It has also been validated in the cooling tunnels with re-use water).

The molybdenum-activated liquid solutions may be used in the following goods:
1) In water and water-related goods, including: bottled water, carbonated water, cologne water, drinking water, effervescent water, flat water, flavored water, glacial water, iceberg water, mineral water, sparkling water, toilet water, vitamin enhanced water, water beds, water for spas, baths, whirlpools and swimming pools, water for the use in livestock and pet feeding, water for use in irrigation of vegetables, plants, trees, crops, water for use in the manufacture of solvents, water for use in the manufacture of paints, water for use in the purification of proteins, and water for use in the manufacture of detergents.
2) In dairy products including milk, milk products, evaporated milk, protein-enriched milk, cocoa beverages with milk, milk beverages containing fruits, cheese, sour cream, powdered milk, butter, cream, cheese spreads, soy-based cheese substitute, dairy cream, whipping cream, ice-cream, ice cream makers. soy-based ice-cream substitute.
3) In alcohol beverages, including alcoholic cocktails, alcoholic coffee-based beverages, alcoholic coolers, alcoholic fruit drinks, alcoholic lemonade, alcoholic malt-based coolers, beers, alcoholic tea-based beverages, sake, vodka, scotch, rum, rye, gin, brandy, cognac, tequila, mezcal, wine.
4) In ice related products including ice, ice cube makers, ice packs, industrial ice.
5) In meats, including beef, pork, fish, poultry, frozen meat, smoked meat, canned meat.
6) In dental industry, including bubble-containing toothpaste, mouthwash, dental floss, dental gel, dental rinses, and denture cleaning preparations.
7) In the pharmaceutical/cosmetic industry, including eye washes, water for use in manufacturing cosmetics, water for use in manufacturing pharmaceuticals and medicinal products.
8) Steam, including steam generators, water for use in manufacturing steam, steam for use in extraction of oils from oil deposits, steam for use in Steam-assisted gravity drainage services.
9) Cleaning, including all-purpose cleaning preparations, carpet cleaning preparations, water for steam sanitation and steam cleaning, water for sanitation, water-based paints.
10) Oils, including anti-rust oil, auxiliary fluids for use with abrasives for the oil well industry, baby oil, bath oil, vegetable, mineral and animal oils, catalysts for use in oil processing, chemical additives for oil well drilling fluid, cooking oil, drilling fluids for oil and gas wells, drilling mud for oil well drilling, edible oil, fuel oil and gasoline production, heating oil, high pressure water jetting system for the gas and oil industry, industrial oil, insulating oil for transformers, motor oil, motor oil additives, oil for use in the manufacture of candles, oil for use in the manufacture of cosmetics, oil for use in the manufacture of paints, rubbing oil for wood, petroleum jelly, diesel fuel, aviation fuel, fuel additives, and fuel for domestic heating.
11) Proteins, protein for use as a food additive, protein for use as a food filler, nutritional supplements, water-processed animal and plant protein.

The molybdenum-activated liquid solutions may preserve flavoring and essences for food. The encapsulation of flavors, fragrances and the like may serve to enhance or alter appearance of food and beverages. Used as a preservative, restore natural nutritional values through the addition of vitamins, minerals and proteins.

The molybdenum-activated liquid solutions may be used to clean and eliminate pollutants found in edible birds' nests, for example, removal of feathers, fungi, nitrates, nitrites and so forth. The molybdenum-activated liquid solutions may make birds' nests more for manual removal of such contaminants while maintaining the original appearances of the nest and retain its nutrition and essences.

The molybdenum-activated liquid solutions may also be used in process, including waste water treatment, water and sewer management, water treatment, food sanitation, carpet cleaning, cleaning of buildings, diaper cleaning, dry cleaning, fur cleaning, jewelry cleaning, leather cleaning, rig cleaning, window cleaning, pool cleaning, automobile (car, trucks, buses, bikes, motorbikes and so forth) washes, train washes, ship washes, airplane washes, oil and gas well treatment, oil refining, fuel treatment, and steam-assisted gravity drainage.

According to Clause 1, a liquid cooling generator is provided which includes: a housing having an inflow portion for receiving a source liquid solution, a treatment portion for treating the source liquid solution, wherein the treatment portion comprises a molybdenum-containing structure, wherein the molybdenum-containing structure is made of a corrosion-resistant alloy including molybdenum, wherein the molybdenum-containing structure is machined or polished to remove scale from a casting process, and an outflow portion for releasing a treated liquid solution wherein the treatment portion comprises at least two contact surface planes separated by cavitation spaces, wherein an endothermic electrochemical oxidative reaction occurs when the source liquid comes into contact with the molybdenum-containing structure which results in cooling of the liquid solution.

According to Clause 2, the liquid cooling generator of Clause 1 is provided, wherein the molybdenum-containing structure includes at least two disc-like elements mounted on a shaft extending axially through the housing, the disc-like elements being separated by a distance, each disc-like element having a first wall facing the inflow portion, a second wall facing the outflow portion and a peripheral wall extending between the first and second walls, the disc-like elements being mounted on a shaft, wherein the disc-like element may be any geometric shape, wherein the distance between the disc-like elements provides for a cavitation space, wherein the contact surface plane forms a surface on the disc-like elements which is machined or polished to remove scale from the casting process.

According to Clause 3, the liquid cooling generator of Clause 1 or Clause 2 is provided, wherein the disc-like elements are made of a metal alloy including about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

According to Clause 4, the liquid cooling generator according to any one of Clauses 1-3 is provided, wherein the metal alloy of the disc-like elements further comprise about 5.0 wt. % or more nickel, about 10.0 wt. % or more nickel, about 15.0 wt. % or more nickel, about 20.0 wt. % or more nickel, about 25.0 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

According to Clause 5, the liquid cooling generator according to any one of Clauses 1-4 is provided, wherein the metal alloy is 316L stainless steel, 317L stainless steel or 904L stainless steel.

According to Clause 6, the liquid cooling generator according to any one of Clauses 1-5 is provided, wherein the disc-like elements include milling scale from the casting process, wherein 100% of the milling scale including dielectric contaminants removed from the surface of the disc-like elements.

According to Clause 7, the liquid cooling generator according to any one of Clauses 1-6 is provided, wherein the disc-like elements are machined or polished with a non-ionic sanding grit which contains no metal contaminants.

According to Clause 8, the liquid cooling generator according to any one of Clauses 1-7 is provided, wherein the at least one edge within the disc-like elements is water jet cut.

According to Clause 9, the liquid cooling generator according to any one of Clauses 1-8 is provided, wherein the liquid cooling generator includes between 2 and 30 disc-like elements.

According to Clause 10, a molybdenum-activated liquid solution generation is provided which includes:
(a) at least one liquid cooling generator, each liquid cooling generator comprising an inflow portion for receiving a source liquid solution, a treatment portion for treating the source liquid solution, and an outflow portion for releasing a cooled molybdenum-activated treated liquid solution, wherein the treatment portion comprises at least two sequential shear planes separated by cavitation spaces wherein the shear planes are made of a corrosion-resistant alloy containing molybdenum, wherein the shear planes are machined or polished to remove scale from a casting process; and
(b) a source of the liquid solution in liquid communication with the inflow portion of the liquid cooling generator.

According to Clause 11, the molybdenum-activated liquid solution generation system of Clause 10 is provided, wherein the liquid cooling generator includes at least two disc-like elements mounted on a shaft extending axially through the housing, the disc-like elements being separated by a distance and containing the shear planes, each disc-like element having a first wall facing the inflow portion, a second wall facing the outflow portion and a peripheral wall extending between the first and second walls, the disc-like elements being mounted on a shaft, wherein the disc-like element may be any geometric shape and wherein the distance between the disc-like elements provides for a cavitation space, wherein the shear plane forms a surface on the disc-like elements which is machined or polished to remove scale from the casting process.

According to Clause 12, the molybdenum-activated liquid solution generation system of Clause 10 or Clause 11 is provided, wherein the system includes one or more of the following components: a source liquid pretreatment system, a high zeta potential crystal generator, a pre-filtration system, at least one filtration device or any combination thereof.

According to Clause 13, the molybdenum-activated liquid solution generation system according to any one of Clauses 10-12 is provided, wherein the liquid cooling generator and the source of the liquid are in liquid communication.

According to Clause 14, the molybdenum-activated liquid cooling generation system according to any one of Clauses 10-13 is provided, wherein the disc-like elements are made of a metal alloy comprising about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

According to Clause 15, the molybdenum-activated liquid cooling generation system according to any one of Clauses 10-14 is provided, wherein the metal alloy of the disc-like elements further comprise about 5.0 wt. % or more nickel, about 10.0 wt. % or more nickel, about 15.0 wt. % or more nickel, about 20.0 wt. % or more nickel, about 25.0 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

According to Clause 16, the molybdenum-activated liquid cooling generation system according to any one of Clauses 10-15 is provided, wherein the metal alloy is 316L stainless steel, 317L stainless steel or 904L stainless steel.

According to Clause 17, the molybdenum-activated liquid cooling generation system according to any one of Clauses 10-16 is provided, wherein the disc-like elements include milling scale from the casting process, wherein 100% of the milling scale including dielectric contaminants removed from the surface of the disc-like elements.

According to Clause 18, the molybdenum-activated liquid cooling generation system according to any one of Clauses 10-17 is provided, wherein the disc-like elements are machined or polished with a non-ionic sanding grit which contains no metal contaminants.

According to Clause 19, the molybdenum-activated liquid cooling generation system according to any one of Clauses 10-18 is provided, wherein the at least one edge within the disc-like elements is water jet cut.

According to Clause 20, the molybdenum-activated liquid cooling generation system according to any one of Clauses 1-19 is provided, wherein the liquid cooling generator includes between 2 and 30 disc-like elements.

According to Clause 21, a method of producing a molybdenum-activated liquid solution including the following steps is provided:
(a) providing a liquid cooling generator comprising an inflow portion for receiving a source liquid solution, a treatment portion for treating the source liquid solution, and an outflow portion for releasing a cooled molybdenum-activated liquid solution, wherein the treatment portion comprises at least two sequential shear planes separated by cavitation spaces a treatment portion for treating the source liquid solution, wherein the shear planes are made of a corrosion-resistant alloy containing molybdenum, wherein the shear planes are machined or polished to remove scale from a casting process; and
(b) passing the source liquid solution through the liquid cooling generator, thereby producing a treated liquid solution that is molybdenum-activated and cooled.

According Clause 22, the method of claim 21 is provided, wherein the treatment portion comprises at least two disc-like elements mounted on a shaft extending axially through the housing, the disc-like elements being separated by a distance, each disc-like element having a first wall facing the inflow portion, a second wall facing the outflow portion and a peripheral wall extending between the first and second walls, the disc-like elements being mounted on a shaft, wherein the disc-like element comprises any geometric shape, wherein the distance between the disc-like elements provides for a cavitation space and wherein the shear plane forms a surface on the disc-like elements which is machined or polished to remove scale from the casting process.

According to Clause 23, the method according to Clause 21 or Clause 22 is provided, wherein the disc-like elements are made of a metal alloy comprising about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

According to Clause 24, the method according to any one of Clauses 21-23 is provided, wherein the metal alloy of the disc-like elements further comprise about 5 wt. % or more nickel, about 10 wt. % or more nickel, about 15 wt. % or more nickel, about 20 wt. % or more nickel, about 25 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

According to Clause 25, the method according to any one of Clauses 21-24 is provided, wherein the metal alloy is 316L stainless steel, 317L stainless steel or 904L stainless steel.

According to Clause 26, the method according to any one of Clauses 21-25 is provided, wherein the disc-like elements include milling scale from the casting process, wherein 100% of the milling scale comprising dielectric contaminants being removed from the surface of the disc-like elements.

According to Clause 27, the method according to any one of Clauses 21-26 is provided, wherein the disc-like elements are machined or polished with a non-ionic sanding grit which contains no metal contaminants.

According to Clause 28, the method according to any one of Clauses 21-27 is provided, wherein the at least one edge within the disc-like elements is water jet cut.

According to Clause 29, the method according to any one of Clauses 21-27 is provided, wherein the liquid cooling generator includes between 2 and 30 disc-like elements.

According to Clause 30, a method of making a liquid cooling generator is provided which includes the following steps:
providing a series of two or more disc-like elements, wherein the disc-like elements comprise a metal alloy including molybdenum, wherein the disc-like elements may be any geometric shape;
machining or polishing the disc-like elements to remove scale from the casting process;
water jet cutting the disc-like elements to form at least one razor sharp edge within the disc-like elements;
mounting the series two or more disc-like elements on a shaft, wherein the disc-like elements being separated by a distance, wherein the distance between the disc-like elements provides for a cavitation space;
providing a chamber; and
inserting the series of two or more sequential disc-like mounted on the shaft within the chamber so that the disc-like elements extend axially through the chamber.

According to Clause 31, the method according to Clause 30 is provided which includes:
fitting the series of two or more sequential disc-like elements mounted on the shaft within the chamber within a housing having an inflow portion for receiving one or more untreated liquids, a treatment portion containing the chamber for treating the one or more untreated liquid, and an outflow portion for releasing the treated one or more liquids, wherein each disc-like element has a first wall facing the inflow portion, a second wall facing the outflow portion and a peripheral wall extending between the first and second wall.

According to Clause 32, the method according to Clause 30 or Clause 31 is provided, wherein the disc-like elements are made of a metal alloy comprising about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

According to Clause 33, the method according to any one of Clauses 30-32 is provided, wherein the metal alloy of the disc-like elements comprise about 5 wt. % or more nickel, about 10 wt. % or more nickel, about 15 wt. % or more nickel, about 20 wt. % or more nickel, about 25 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

According to Clause 34, the method according to any one of Clauses 30-33 is provided, wherein the metal alloy of the disc-like elements comprise 316L stainless steel, 317L stainless steel or 904L stainless steel.

According to Clause 35, the method according to any one of Clauses 30-34 is provided, wherein the step of machining or polishing the disc-like elements to remove scale from the casting process includes removing 100% of the milling scale including dielectric contaminants from the surface of the disc-like elements.

According to Clause 36, the method according to any one of Clauses 30-35 is provided, wherein the step of machining or polishing the disc-like elements to remove scale from the casting process comprises using a non-ionic sanding grit which contains no metal contaminants.

According to Clause 37, the method according to any one of Clauses 30-36 is provided, wherein the step of machining or polishing the disc-like elements to remove scale from the casting process is completed to a Number 4 Grade.

According to Clause 38, the method according to any one of Clauses 30-37 is provided, wherein the water jet cutting of the disc-like elements is completed using a Number 5 Grade water jet cut.

According to Clause 39, the method according to any one of Clauses 30-38 is provided, wherein the surface of the disc-like elements are covered in plastic while being water jet cut.

According to Clause 40, the method according to any one of Clauses 30-39 is provided, wherein there is no heat applied to the surface of disc-like elements.

According to Clause 41, a reverse flow apparatus is provided which includes:
a chamber having a series of two or more sequential disc-like elements mounted on a shaft extending axially through the chamber, the disc-like elements being separated by a space, each disc-like elements comprising a surface, at least one edge, a circumference and one or more S-shaped members extending from a point in the circumference to another point in the circumference and across a center of the disc-like element, the two or more sequential disc-like elements being mounted along the shaft in a twist arrangement such that at least one disc-like element in the apparatus has its S-shaped member in a forward-facing position and at least one disc-like element in the apparatus has its S-shaped member in a reverse-facing position,
wherein the disc-like elements comprise a metal alloy comprising at least 0.5 wt. or greater molybdenum and at least 5 wt. % or greater nickel, wherein the disc-like elements are machined or polished to remove scale from the casting process,
wherein an endothermic electrochemical oxidative reaction occurs within the chamber when a liquid comes into contact with the disc-like elements which results in cooling of the liquid.

According to Clause 42, the reverse flow apparatus according to Clause 41 is provided, wherein the spiral apparatus includes a housing having an inflow portion for receiving one or more untreated liquids, a treatment portion containing the chamber for treating the one or more untreated liquid, and an outflow portion for releasing the treated one or more liquids.

According to Clause 43, the reverse flow apparatus according to Clause 41 or Clause 42 is provided, wherein the disc-like elements are made of stainless-steel containing molybdenum (Mo) and nickel (Ni).

According to Clause 44, the reverse flow apparatus according to any one of Clauses 41-43 is provided, wherein the disc-like elements are made of a metal alloy including about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

According to Clause 45, the reverse flow apparatus according to any one of Clauses 41-44 is provided, wherein the metal alloy of the disc-like elements includes about 5 wt. % or more nickel, about 10 wt. % or more nickel, about 15 wt. % or more nickel, about 20 wt. % or more nickel, about 25 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

According to Clause 46, the reverse flow apparatus according to any one of Clauses 41-45 is provided, wherein the metal alloy of the disc-like elements includes 316L stainless steel, 317L stainless steel or 904L stainless steel.

According to Clause 47, the reverse flow apparatus according to any one of Clauses 41-46 is provided, wherein 100% of the milling scale comprising dielectric contaminants being removed from the surface of the disc-like elements.

According to Clause 48, the reverse flow apparatus according to any one of Clauses 41-47 is provided, wherein the disc-like elements are machined or polished with a non-ionic sanding grit which contains no metal contaminants.

According to Clause 49, the reverse flow apparatus according to any one of Clauses 41-48 is provided, wherein the at least one edge within the disc-like elements is water jet cut.

According to Clause 50, a method of making a reverse flow apparatus is provided which includes the following steps:
providing a series of two or more sequential disc-like elements, wherein the disc-like elements comprise a metal alloy comprising at least 0.5 wt. % or greater molybdenum and at least 5 wt. % or greater nickel, wherein each disc-like element comprises a surface, a circumference and one or more S-shaped members extending from a point in the circumference to another point in the circumference and across a center of the disc-like element;
machining or polishing the disc-like elements to remove scale from the casting process;
water jet cutting the disc-like elements to form at least one razor sharp edge within the disc-like elements;
mounting the series two or more disc-like elements on a shaft, wherein the two or more sequential disc-like elements are mounted along the shaft in a twist arrangement such that at least one disc-like elements in the apparatus has its S-shaped member in a forward-facing position and at least one disc-like elements in the apparatus has its S-shaped member in a reverse-facing position;
providing a chamber; and
inserting the series of two or more sequential disc-like elements mounted on the shaft within the chamber so that the disc-like elements extend axially through the chamber.

According to Clause 51, the method according to Clause 50 is provided which includes the step of fitting the series of two or more sequential disc-like elements mounted on the shaft within the chamber within a housing having an inflow portion for receiving one or more untreated liquids, a treatment portion containing the chamber for treating the one or more untreated liquid, and an outflow portion for releasing the treated one or more liquids.

According to Clause 52, the method according to Clause 50 or Clause 51 is provided, wherein the disc-like elements are made of stainless-steel containing molybdenum (Mo) and nickel (Ni).

According to Clause 53, the method according to any one of Clauses 50-52 is provided, wherein the disc-like elements are made of a metal alloy including about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

According to Clause 54, the method according to any one of Clauses 50-53 is provided, wherein the disc-like elements are made of a metal alloy including about 5 wt. % or more nickel, about 10 wt. % or more nickel, about 15 wt. % or more nickel, about 20 wt. % or more nickel, about 25 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

According to Clause 55, the method according to any one of Clauses 50-54 is provided, wherein the metal alloy of the disc-like elements includes 316L stainless steel, 317L stainless steel or 904L stainless steel.

According to Clause 56, the method according to any one of Clauses 50-55 is provided, wherein the step of machining or polishing the disc-like elements to remove scale from the casting process includes removing 100% of the milling scale including dielectric contaminants from the surface of the disc-like elements.

According to Clause 57, the method according to any one of Clauses 50-56 is provided, wherein the step of machining or polishing the disc-like elements to remove scale from the casting process comprises using a non-ionic sanding grit which contains no metal contaminants.

According to Clause 58, the method according to any one of Clauses 50-57 is provided, wherein the step of machining or polishing the disc-like elements to remove scale from the casting process is completed to a Number 4 Grade.

According to Clause 59, the method according to any one of Clauses 50-58 is provided, wherein the water jet cutting of the disc-like elements is completed using a Number 5 Grade water jet cut.

According to Clause 60, the method according to any one of Clauses 50-59 is provided, wherein the surface of the disc-like elements are covered in plastic while being water jet cut.

According to Clause 61, the method according to any one of Clauses 50-60 is provided, wherein there is no heat applied to the surface of disc-like elements.

According to Clause 62, a system for treating liquid solutions or emulsion is provided, the system including a source of the liquid solution or emulsion and a reverse flow apparatus according to any of Clauses 41 to 49, the inflow portion of the reverse flow apparatus being operatively connected to the source and which injects the liquid solution or emulsion into the chamber at a pressure of 125 or about 125 psi, at a pressure ranging from about 70 to about 125 psi or at a pressure greater than 125 psi.

According to Clause 63, the system according to Clause 62 is provided, wherein the system further includes at least one of a filtration device, a UV sterilizer and a Z potential crystal generator, wherein the reverse flow apparatus, the source and the at least one of the filtration device, the UV sterilizer and the Z potential crystal generator are in liquid communication with one another.

According to Clause 64, the system according to Clause 62 or Clause 63 is provided, wherein the system further includes a filtration device, a UV sterilizer and a Z potential crystal generator, wherein the reverse flow apparatus, the source, the filtration device, the UV sterilizer and the Z potential crystal generator are in liquid communication with one another.

According to Clause 65, the system according to any one of Clauses 62-64 is provided, wherein the system includes multiple reverse flow apparatuses according to any one of Clauses 41 to 49.

According to Clause 66, a liquid emulsion processed with the reverse flow apparatus according to any one of Clauses 41 to 49 is provided.

According to Clause 67, the liquid emulsion according to Clause 66 is provided, wherein the liquid emulsion is an oil-in-water emulsion.

According to Clause 68, a method of cracking an oil-in-water emulsion is provided, the method including passing the oil-in-water emulsion though the reverse flow apparatus according to any one of Clauses 41 to 49 to obtain a processed material whereby a separate aqueous phase and oil phase is produced, wherein cracking of the oil-in-water emulsion occurs at a pressure of about 70 to about 125 psi, of 125 psi or greater than 125 psi.

According to Clause 69, the method according to Clause 68 is provided, wherein the method further includes pyrolyzing the oil-in-water emulsion to obtain a derivative, and wherein the method includes passing the derivative, instead of the oil-in-water emulsion, through the reverse flow apparatus according to any one of Clauses 41 to 49.

According to Clause 70, the method according to Clause 68 or Clause 69 is provided, wherein the cracking of the oil-in-water emulsion does not include the addition of flocculants within the reverse flow apparatus according to any one of claims 41-49.

According to Clause 71, the method of cracking the oil-in-water emulsion according to any one of Clauses 68-70 is provided, wherein the oil-in-water emulsion is oily wastewater, a petroleum feedstock or a part of a secondary oil recovery system.

According to Clause 72, a method of lowering the viscosity of liquid solution or emulsion containing oil is provided, the method including passing the liquid solution or emulsion containing oil through the reverse flow apparatus according to any one of Clauses 41 to 49 to obtain a processed material having lower viscosity than the liquid solution or emulsion containing oil, thereby lowering the viscosity of the liquid solution or emulsion containing oil.

According to Clause 73, a method of cracking a liquid including passing the liquid through the reverse flow apparatus of any one of Clauses 41 to 49 to obtain a cracked liquid.

According to Clause 74, the method of cracking a liquid according to Clause 73 is provided, wherein the cracked liquid contains contain more hydrocarbons having shorter carbon chain species relative to the liquid.

According to Clause 75, the method of cracking a liquid according to Clause 73 or Clause 74, wherein the method is devoid of solvents.

According to Clause 76, the method of cracking a liquid of any one of Clauses 73-75 is provided, wherein the liquid is an emulsion, a petroleum feedstock or a part of a secondary oil recovery system.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. The phrase “associated with” as used in this document, refers to structures which support the disclosed device and may also refer to structures not disclosed herein capable of supporting the disclosed device. Further, the “invention” as that term is used in this document is what is claimed in the claims of this document. The right to claim elements and/or sub-combinations that are disclosed herein as other inventions in other patent documents is hereby unconditionally reserved.

1-76. (canceled)

77. A method of processing a hydrocarbon-bearing source material, the method comprising:
passing the hydrocarbon-bearing source material though an apparatus at a pressure within a range of about 70 psi to about 125 psi, the apparatus including:
an inflow portion for receiving the hydrocarbon-bearing source material,
a treatment portion for treating the hydrocarbon-bearing source material, wherein the treatment portion includes a molybdenum-containing structure made of a corrosion-resistant alloy including molybdenum, wherein the treatment portion further includes at least two contact surface planes separated by cavitation spaces, and
an outflow portion for outputting a hydrocarbon-bearing processed material;
taking the processed material from the output.

78. The method of claim 77, wherein the hydrocarbon-bearing source material comprises an oil-in-water emulsion, and wherein the hydrocarbon-bearing processed material comprises separate aqueous and oil phases.

79. The method of claim 78 further comprising pyrolyzing the oil-in-water emulsion to obtain a derivative and passing the derivative through the apparatus.

80. The method of claim 78, wherein the oil-in-water emulsion comprises oily wastewater, a petroleum feedstock, or part of a secondary oil recovery system.

81. The method of claim 77 performed without the addition of a flocculant.

82. The method of claim 77, further comprising an endothermic electrochemical oxidative reaction occurring when the hydrocarbon-bearing source material contacts the molybdenum-containing structure which results in cooling of the hydrocarbon-bearing source material.

83. The method of claim 77, wherein the hydrocarbon-bearing source material comprises a liquid solution or emulsion containing oil, and wherein the hydrocarbon-bearing processed material has a lower viscosity than the hydrocarbon-bearing source material.

84. A system to process a hydrocarbon-bearing source material, the system comprising:
a machine to pressurize the hydrocarbon-bearing source material; and
an apparatus comprising:
a housing having an inflow portion connected to the machine to receive the hydrocarbon-bearing source material at a pressure of within a range of about 70 psi to about 125 psi;
a treatment portion for treating the hydrocarbon-bearing source material, wherein the treatment portion includes a molybdenum-containing structure made of a corrosion-resistant alloy including molybdenum, wherein the treatment portion further includes at least two contact surface planes separated by cavitation spaces; and
an outflow portion to output a hydrocarbon-bearing processed material.

85. The system of claim 84, wherein the hydrocarbon-bearing source material comprises an oil-in-water emulsion, and wherein the hydrocarbon-bearing processed material comprises separate aqueous and oil phases.

86. The system of claim 84, wherein the molybdenum-containing structure is machined or polished to remove scale from a casting process.

87. The system of claim 84, wherein the molybdenum-containing structure comprises at least two disc-like elements are mounted on a shaft extending axially through the housing, the disc-like elements being separated by a distance, each disc-like element having a first wall facing the inflow portion, a second wall facing the outflow portion and a peripheral wall extending between the first and second walls, the disc-like elements being mounted on a shaft, wherein the disc-like element comprises any geometric shape, wherein the distance between the disc-like elements provides for a cavitation space.

88. The system of claim 87, wherein the contact surface plane forms a surface on the disc-like elements which is machined or polished to remove scale from a casting process.

89. The system of claim 87, wherein the disc-like elements are made of a metal alloy comprising about 1.0 wt. % or more molybdenum, about 1.5 wt. % or more molybdenum, from about 3.0 wt. % to about 4.0 wt. % molybdenum, from about 4.0 wt. % to about 4.5 wt. % molybdenum, from about 4.0 wt. % to about 5.0 wt. % molybdenum, from about 5.0 wt. % to about 6.0 wt. % molybdenum, from about 6.0 wt. % to about 7.0 wt. % molybdenum, from about 7.0 wt. % to about 8.0 wt. % molybdenum, from about 8.0 wt. % to about 9.0 wt. % molybdenum, from about 9.0 wt. % to about 10.0 wt. % molybdenum, from about 10.0 wt. % to about 15.0 wt. % molybdenum, from about 15.0 wt. % to about 20.0 wt. % molybdenum, from about 20.0 wt. % to about 25.0 wt. % molybdenum, from about 25.0 wt. % to about 30.0 wt. % molybdenum, from about 30.0 wt. % to about 35.0 wt. % molybdenum, from about 35.0 wt. % to about 40.0 wt. % molybdenum, from about 0.5 wt. % to about 40.0 wt. % molybdenum, or up to about 40 wt. % molybdenum.

90. The system of claim 89, wherein the metal alloy of the disc-like elements further comprise about 5.0 wt. % or more nickel, about 10.0 wt. % or more nickel, about 15.0 wt. % or more nickel, about 20.0 wt. % or more nickel, about 25.0 wt. % or more nickel, from about 5.0 wt. % to about 10.0 wt. % nickel, from about 10.0 wt. % to about 15.0 wt. % nickel, from about 15.0 wt. % to about 20.0 wt. % nickel, or from about 20.0 wt. % to about 25.0 wt. % nickel.

91. The system of claim 90, wherein the metal alloy is 316L stainless steel, 317L stainless steel, or 904L stainless steel.

92. The system of claim 87, wherein a surface of the disc-like elements is free of dielectric contaminants.

93. The system of claim 87, wherein the disc-like elements are machined or polished with a non-ionic sanding grit which contains no metal contaminants.

94. The system of claim 87, wherein the at least one edge within the disc-like elements is water jet cut.

95. The system of claim 87, wherein apparatus includes between 2 and 30 disc-like elements.

96. The system of claim 84, wherein the hydrocarbon-bearing source material comprises a liquid solution or emulsion containing oil, and wherein the hydrocarbon-bearing processed material has a lower viscosity than the hydrocarbon-bearing source material.
